(19) United States
(12) Patent Application Publication
(10) Pub. No.: US 2007/0131674 A1
(43) Pub. Date: Jun. 14, 2007

(54) Ceramic heater, method for producing ceramic heater, and heater power-supply component

(75) Inventors: Takuma Kushihashi, Gunma (JP); Noboru Kimura, Gunma (JP); Mitsuhiro Kanai, Gunma (JP); Yoshihiko Shimizu, Gunma (JP); Akihiko Hara, Gunma (JP)

Correspondence Address: OLIFF & BERRIDGE, PLC, P.O. BOX 19928, ALEXANDRIA, VA, 22320, US

(73) Assignee: SHIN-ETSU CHEMICAL CO., LTD., CHIYODA-KU (JP)

(21) Appl. No.: 11/633,039

(22) Filed: Dec. 4, 2006

(30) Foreign Application Priority Data
Dec. 8, 2005 (JP) 2005-355426
Mar. 17, 2006 (JP) 2006-073790

(51) Int. Cl. H05B 3/16

(52) U.S. Cl. 219/543

(57) ABSTRACT

There is disclosed a ceramic heater 11 comprising: a plate member 12 made of insulating ceramics in which one or more pair(s) of through-holes 13 are formed; a conductive layer 19 made of conductive ceramics; and a coating layer 21 made of insulating ceramics; wherein a joint member 14 made of conductive ceramics is inserted into the through-hole; an end face 16 of the joint member has a same plane with a main surface 15 of the plate member; the joint member is coated with the conductive layer 19 and thereby fixed to the plate member and also connected with the conductive layer having a heater pattern 20; and an opposite side of the joint member projects from the plate member and the projecting portion 18 constitutes a terminal on which the coating layer is not formed. There can be provided a ceramic heater by which an object to be heated being put directly thereon can be heated uniformly and of which heating efficiency is high and in which the heater main body is not large in size and is compact and scattering of impurities or particles is small and which has a long operating life and is inexpensive.

### BACKGROUND OF THE INVENTION

1. Field of the Invention

The present invention relates to, a ceramic heater used for heating a semiconductor wafer in semiconductor production process or for heating a substrate when a thin film is formed according to chemical vapor deposition method or sputtering method, a method for producing the ceramic heater, and a heater power-supply component.

2. Description of the Related Art

As a ceramic heater used for heating a semiconductor wafer in semiconductor production process or for heating a substrate when a thin film is formed according to chemical vapor deposition method or sputtering method, there has been used a heater having a structure in which a heating element consisting of metal foil or rolled circuit or a heating element formed by screen-printing a conductive paste containing metal particles or conductive ceramic particles is buried in a supporting substrate made of sintered body such as silicon nitride, aluminum nitride, or boron nitride (see, Japanese Patent Laid-open (Kokai) No. 2004-220966; and Japanese Patent Laid-open (Kokai) No. 2004-253799).

However, in the case of forming a heater pattern by screen-printing, film thickness of the heating layer easily becomes non-uniform, and therefore, occasionally, the heater does not have good heating uniformity. Moreover, there is possibility that organic matter contained in paste used for screen-printing or component of a sintering auxiliary agent contained in a ceramic sintered body becomes a source origin of impurity.

On the other hand, if a conductive layer made of pyrolytic graphite is made by chemical vapor deposition method on a supporting substrate made of pyrolytic boron nitride generated by chemical vapor deposition method and a desired heater pattern is formed by machining therein and furthermore the heater pattern is coated with a coating layer made of pyrolytic boron nitride according to chemical vapor deposition method, a conductive layer having a uniform film-thickness can be easily obtained and a ceramic heater having good heating uniformity can be provided (see, Japanese Patent No. 3560456).

Moreover, because all of the supporting substrate, the conductive layer, and the coating layer, are produced by chemical vapor deposition method, they have higher purity than ones produced by sintering method and have an advantage of a semiconductor wafer being difficult to be contaminated with impurities and are advantageous in heating process.

In the heater in which a conductive layer made of pyrolytic graphite is made by chemical vapor deposition method on a supporting substrate made of pyrolytic boron nitride generated by chemical vapor deposition method and a desired heater pattern is formed by machining therein and furthermore the heater pattern is coated with a coating layer made of pyrolytic boron nitride according to chemical vapor deposition method, through-holes are provided on both ends of the heater pattern and the coating layer at periphery of the through-hole is removed to expose the conductive layer, and a conductive wire from a power source is fixed to the exposed part of the conductive layer by a bolt and a nut that are made of metal or carbon material such as graphite, carbon, or carbon complex material, and thereby the heater is connected to the power source.

However, according to the above connection method, in an atmosphere being reactive with carbon, the conductive layer being exposed at the part connected to the power source is wasted and causes abnormal heat generation, and if it is more wasted, electric discharge is caused and the heater becomes damaged. Therefore, there is a problem that use conditions of the heater (heating temperature, atmosphere) are limited. Moreover, in the case that a bolt and a nut that are made of graphite, carbon, carbon complex material, or the like, are used, they become a source origin of particles. Moreover, in the case that a bolt and a nut that are made of metal, particles are difficult to be generated in some time period from an initiation of use, compared to the case that a bolt and a nut that are made of graphite, carbon, carbon complex material, or the like. However, if they continue to be used for a long period, they are degraded with heat even if they are a bolt and a nut made of metal. Ultimately, there is a problem that they become a source origin of particles. Also, there is a risk of causing metal contamination of a semiconductor wafer to be treated.

For solving these problems, a ceramic heater described in Japanese Patent No. 2702609 can be exemplified. This is a ceramic heater having a structure in which a heater main body is provided with a heater pattern made of pyrolytic graphite on a substrate made of pyrolytic boron nitride and through-holes are provided in contact ends located in the both ends of the heater pattern and graphite rod members having a predetermined length are fixed through the through-holes using graphite screws so as to be located in the face opposite to the heater patter and then the heater main body and the graphite screws and graphite rod members are integrally coated with a coating layer made of pyrolytic boron nitride.

And, for strengthening mechanically and electrically the attachment of the graphite screws and the graphite rod members, flexible graphite washers are placed between the graphite screw and the heater main body and between the heater main body and the graphite rod member. At the other end of the graphite rod member opposite to the end fixed to the heater main body by the graphite screw, the coating layer made of pyrolytic boron nitride is not formed and a conductive wire from a power source is connected to this part.

In the heater described in Japanese Patent No. 2702609, the conductive layer made of pyrolytic graphite to form the heater pattern, the graphite screws, and the members made of carbon material such as graphite rod members, are almost entirely coated with a coating layer made of pyrolytic boron nitride. Therefore, it becomes a heater available even in an atmosphere having reactivity with carbon, and generation of particles from the graphite screws, the graphite rod members, or the like, can be suppressed.

Furthermore, in the other end of the graphite rod member opposite to the end fixed to the heater main body by the graphite screw, the coating layer made of pyrolytic boron nitride is not formed and a conductive wire from a power source is connected to this part. However, because this part is apart from the heater pattern by the distance of the length of the graphite rod member having the predetermined length, temperature thereof is suppressed to be low. Accordingly, if the heater is used in an atmosphere having reactivity with carbon, degradation thereof is small to some extent. Moreover, if the screw made of metal is used for the connection of the conductive wire, the metal screw hardly becomes a source origin of particles by degradation with heat because the temperature is low.

Here, as main methods for heating a semiconductor wafer with a ceramic heater, there are a method for heating the semiconductor wafer with radiant light from the heater without contact between the wafer and the heater, and a method for heating the semiconductor wafer by heat conduction with putting the wafer directly on the heater.

In the case of performing the radiant heating under a reduced pressure, as use time thereof becomes longer, the heater surface is contaminated by film adhesion due to wrap-around of process gas or by adhesion of scattered things from the peripheral members. Therefore, radiation rate is changed and it occasionally become impossible that a semiconductor wafer is heated in the same manner even with the same electric power. Such a phenomenon is particularly significant in a high-temperature process of 1000° C. or more.

In the case of the heating by directly putting, there are not such problems. Moreover, the heating by directly putting is better in heating efficiency than the radiant heating. Therefore, the heating by directly putting is more appropriate in cost in a high-temperature process.

However, in the heater described in Japanese Patent No. 2702609, the head of the graphite screw for fixing the graphite rod member projects out of the heating surface of the heater. Therefore, in the case of directly putting an object to be heated and heating it, as shown in FIG. 11, positions (the head 42 of the screw of the rod members) in which graphite rod members are provided have to be necessarily outside the region 1 on the heater on which the object to be heated is put. Therefore, there is a problem that the heater becomes large in size. Also, the heater according to Japanese Patent No. 3560456 has the same problem, and a screw or a nut for fixing a conductive wire from a power source projects out of the heating surface of the ceramic heater. Therefore, in the case of directly putting an object to be heated on the heater and heating it, positions in which conductive wires are provided have to be necessarily outside the region on the heater on which the object to be heated is put. All the same, the heater becomes large in size.

Moreover, as diameter of a semiconductor wafer has become enlarged in recent years, a large heater has become used as a heater for heating such a wafer. However, in order that current value and power voltage value are made not to be too large or that temperature distribution of the semiconductor wafer is made to be improved, there is frequently used a heater having a two-zone system in which a first heating region in the vicinity of the heater center to be heated by a first power source and a second heating region in the outside thereof to be heated by a second power source are provided and the heater is heated by two power sources.

In the case that a semiconductor wafer is directly put and heated on the heater having a two-zone system in the heater having the structure described in Japanese Patent No. 2702609, with respect to the shape of the first heating region and the second heating region of the heater, there is no other choice but the shape is made to be one shown in FIG. 10 because the head of the graphite screw projects out of the heating surface of the heater. Also, the case of the heater having a two-zone system in the heater having the structure described in Japanese Patent No. 3560456 is similar thereto, and therefore, in the case of directly putting a semiconductor wafer thereon and heating it, with respect to the shape of the first heating region and the second heating region of the heater, there is no other choice but the shape is made to be one shown in FIG. 10. The reason is the follow. In the heater having the structure described in Japanese Patent No. 3560456, through-holes are provided in both ends of the heater pattern and the coating layer in the periphery of the through-hole are removed and thereby to expose the conductive layer and a conductive wire from a power source is fixed to the conductive-layer exposed part with a bolt and a nut and thereby the heater is connected to the power source. Therefore, the bolt and the nut project out of the heating surface of the heater.

The problem of the shape of the heater pattern in FIG. 10 is the follow.

The semiconductor wafer is put on the region inside the dashed line 1 in FIG. 10. The central part of the heater is the first heating region 2 and the outside thereof is the second heating region 3. Graphite rod members 4 connected to the first heating region 2 and graphite rod members 5 connected to the second heating region 3 are respectively provided in the most peripheral part of the heater. That is, because the graphite rod members 4 connected to the first heating region 2 located in the vicinity of the central part of the heater are provided in the most peripheral part of the heater, the conductive pathways 6 connecting the first heating region 2 and the graphite rod members 4 have to be provided in the second heating region 3.

Therefore, in the second heating region 3 to be heated by the second power source, there is a heating element to be heated by the first power source. Depending on electric power balance of the first power source and the second power source, the conductive pathways 6 become local heating parts or local low-temperature parts. Therefore, there is a problem that temperature distribution of the wafer is harmfully affected thereby.

Furthermore, in such a heater in which the heater main body and graphite screws and graphite rod members are integrally coated with a coating layer made of pyrolytic boron nitride as the heater described in Japanese Patent No. 2702609, in the case that the graphite rod member or the coating layer made of pyrolytic boron nitride coating the graphite rod members or the like are damaged, there is a problem that the whole of the heater has to be exchanged even in the state that the heater main body in itself has none of abnormality and that normal heating is possible. Therefore, to load the heater having the above structure on a production apparatus for a semiconductor and so forth has been a factor of a significant cost rise.

### SUMMARY OF THE INVENTION

The present invention has been accomplished to solve the above-mentioned problems, and a main object of the present invention is to provide a ceramic heater by which an object to be heated being put directly thereon can be heated uniformly and of which heating efficiency is high and in which the heater main body is not large in size and is compact and scattering of impurities or particles is small and which has a long operating life and is inexpensive, a method for producing the ceramic heater, and a heater power-supply component.

To achieve the above object, the present invention provides a ceramic heater comprising: at least

a plate member made of insulating ceramics in which one or more pair(s) of through-holes are formed;

a conductive layer made of conductive ceramics formed on the plate member; and

a coating layer made of insulating ceramics formed on the conductive layer;

wherein a joint member made of conductive ceramics is inserted into the through-hole of the plate member;

an end face of the joint member inserted into the through-hole has a same plane with a main surface of the plate member on which the conductive layer is formed;

the joint member is coated with the conductive layer and thereby fixed to the plate member and also connected with the conductive layer having a heater pattern formed on a main surface of the plate member; and

a side of the joint member opposite to a side thereof inserted into the through-hole of the plate member projects from the plate member and the projecting portion constitutes a terminal on which the coating layer is not formed.

When an end face of the joint member has a same plane with a main surface of the plate member and is connected with the conductive layer having a heater pattern formed on a main surface of the plate member, it is not necessary that the positions in which the joint members are provided are made to be outside the region on the plate member on which an object to be heated is put. Therefore, the heater main body does not become large in size and has a compact structure. By the heater pattern formed on the same plane, the ceramic heater can heat uniformly an object to be heated being put directly on the flat heater with high heating efficiency.

Furthermore, when the joint member projects from the plate member and the projecting portion constitutes a terminal on which the coating layer is not formed, the joint member can be connected to a conductive member being separately provided and is difficult to be damaged and the conductive member can be exchanged even when damaged, and therefore, the operating life of the heater becomes long and production cost can be reduced.

Moreover, the joint member is coated with the conductive layer and thereby fixed to the plate member, and therefore, contact of the conductive layer and the joint member is good and the durability is enhanced without using a screw or the like that is easily damaged by the heater heat and the heater weight, and the operating life of the heater becomes long.

Moreover, the present invention provides a method for producing a ceramic heater, comprising at least steps of:

forming one or more pair(s) of through-holes in a plate member made of insulating ceramics;

forming a conductive layer made of conductive ceramics on the plate member; and then

forming a coating layer made of insulating ceramics on the conductive layer;

wherein a joint member made of conductive ceramics is inserted into the through-hole of the plate member so that an end face of the joint member inserted into the through-hole has a same plane with a main surface of the plate member and so that a side of the joint member opposite to a side thereof inserted into the through-hole projects from the plate member; then

the conductive layer is formed so that the joint member and the plate member are integrally coated therewith and thereby the joint member and the plate member are firmly fixed;

a heater pattern is formed by processing the conductive layer on a main surface of the plate member; and then

the coating layer is formed so that the plate member and the joint member and the conductive layer are integrally coated therewith except the projecting portion of the joint member.

When the joint member is inserted into the through-hole of the plate member so that an end face of the joint member has a same plane with a main surface of the plate member and a heater pattern is formed by processing the conductive layer on a main surface of the plate member, it is not necessary that the positions in which the joint members are provided are made to be outside the region on the plate member on which an object to be heated is put. Therefore, a ceramic heater that the heater main body does not become large in size and has a compact structure in and that an object to be heated being put directly on the flat heater can be heated uniformly with high heating efficiency by the heater pattern formed by processing the conductive layer on a main surface of the plate member in can be produced at low cost.

Moreover, when the joint member projects from the plate member and the coating layer is formed except the projecting portion, the projecting portion comes to constitute a terminal and can be connected to a conductive member being separately provided. Therefore, the conductive member can be exchanged even when damaged, and therefore, the heater having a long operating life can be produced.

Furthermore, by forming the conductive layer so that the joint member and the plate member are integrally coated therewith, the joint member and the plate member can be firmly fixed. In particular, by chemically vapor-depositing a conductive ceramic material on the whole of the joint member and the plate member, the joint member and the plate member can be firmly fixed easily and it is not necessary to use screw and such. It is not necessary to use a screw that is easily damaged by the heater heat and the heater weight.

Also, production cost can be reduced because the heater having a simple structure and being difficult to be damaged can be easily produced.

In the above case, it is preferable that the joint member is pressed-fit into the through-hole of the plate member.

When the joint member is inserted into the through-hole of the plate member by press-fit, the contact of the conductive layer and the joint member can be good and cross-section area of the joint member can be small without using a screw that causes a trouble of breaking due to the heater heat and the heater weight and so forth for connecting the plate member and the joint member. Therefore, amount of heat to outflow to the outside can be suppressed to small and the object to be heated can be heated uniformly with higher heating efficiency. Moreover, there is no scattering of impurities because it is not necessary to use a bolt and a nut being a source origin of particles, and therefore, the heater is applicable to heating process in which high purity is required. In this case, it is preferable that after the press-fit, flat-surface processing is performed by flat-surface grinding of the main surface or the like so that an end face of the joint member and the main surface of the plate member have an accurately same plane.

Here, the heater pattern can be formed on the main surface of the plate member having the same plane with the end face in the side of the joint member inserted into the through-hole of the plate member and/or on a main surface opposite to the main surface, and in the main surface on which the heater pattern is not formed, the joint members are electrically insulated not to be short-circuited to each other.

When the heater pattern is formed on the main surface of the plate member having the same plane with the end face in the side of the joint member inserted into the through-hole of the plate member and/or on a main surface opposite to the main surface and the joint members are electrically insulated not to be short-circuited to each other in the main surface on which the heater pattern is not formed, the heater becomes capable of heating an object to be heated being put directly on the flat heater uniformly with high heating efficiency.

Furthermore, it is preferable that the plate member is made of any one of, pyrolytic boron nitride, pyrolytic boron nitride containing carbon, pyrolytic boron nitride containing silicon, and pyrolytic boron nitride containing aluminum.

When any one of pyrolytic boron nitride and pyrolytic boron nitride containing carbon and pyrolytic boron nitride containing silicon and pyrolytic boron nitride containing aluminum is used as the plate member, the plate member can be produced by chemical vapor deposition method, and even when used at a high temperature, the heater is stable and causes no scattering of impurities, and therefore, the heater also becomes applicable to heating process in which high purity is required.

Here, in the case that the plate member is made of pyrolytic boron nitride containing carbon or pyrolytic boron nitride containing silicon or pyrolytic boron nitride containing aluminum, resistivity of the plate member becomes smaller as the carbon content or the silicon content or the aluminum content becomes larger. It is necessary that the carbon content or the silicon content or the aluminum content is suppressed to amount by which insulation can be held at gaps of the heater pattern.

Moreover, it is preferable that the joint member is made of any one of, graphite, sintered silicon carbide, and sintered boron carbide.

When any one of graphite and sintered silicon carbide and sintered boron carbide is used as the joint member, heat resistance thereof is excellent, and additionally, the conductive layer and the coating layer are coated on the outer surface thereof, and therefore, there is no scattering of impurities, and the heater becomes applicable to heating process in which high purity is required. In particular, graphite is more preferable because it is relatively inexpensive and easy to be processed.

Furthermore, it is preferable that the conductive layer is made of any one of pyrolytic graphite and pyrolytic graphite containing boron and/or boron carbide.

When the conductive layer is formed by chemically vapor-depositing any one of pyrolytic graphite and pyrolytic graphite containing boron and/or boron carbide, the conductive layer is easier to be processed than metal foil or rolled circuit, and therefore, the heater comes to make it easy that as the heater pattern having meandering pattern, width and thickness thereof are changed and thereby to make a discretionary temperature gradient therein or to make a heating distribution therein according to the heat environment to uniform the heat. Furthermore, if chemical vapor deposition method is used, the thickness of the conductive layer can be more uniform than that of a method of coating a conductive paste by screen-printing.

Moreover, it is preferable that the projecting portion of the joint member is inserted into a concave portion provided on one end of a conductive member with a rod shape that is a separate member from the joint member and that is made of conductive ceramics or metal, and thereby connected with the conductive member.

When the projecting portion of the joint member is connected with the conductive member with being inserted into a concave portion provided on one end of a conductive member with a rod shape that is a separate member from the joint member and that is made of conductive ceramics or metal, a power terminal for being connected with a conductive wire or the like is provided in the other end opposite to the one end in which the concave portion of the conductive member with a rod shape is provided, and thereby, there is a sufficient distance between the power terminal and the heater main body. Therefore, the temperature is low at the power terminal for being connected with the conductive wire or the like. Degradation of such a member as a crimping terminal or a bolt or a screw or a nut or the like which is used in the connection, and scattering of particles due thereto, can be suppressed.

Moreover, because the conductive member is a separate member from the heater main body, in the case that the conductive member or the protection layer formed thereon is damaged, it is sufficient that only the member is exchanged, and therefore, the heater comes to have a long operating life and to be inexpensive.

Furthermore, it is preferable that the ceramic heater includes a heater power-supply component that is connected to the projecting portion of the joint member and that is a separate member from the joint member;

the heater power-supply component includes, a conductive member with a rod shape made of conductive ceramics having a concave portion in one end thereof that the projecting portion of the joint member is inserted into and connected with and having a power terminal in another end thereof to be connected to a power source, and a protection layer made of insulating ceramics provided on an outer surface of the conductive member; and

a distance from an outermost part of an end face in the one end that the joint member is connected with to the concave portion therein is 3 mm or more.

When the ceramic heater includes a heater power-supply component that is connected to the projecting portion of the joint member and that is a separate member from the joint member, the heater becomes difficult to be damaged. For example, even when the heater power-supply component or particularly a protection layer provided therein is damaged, only the component can be exchanged. Therefore, the operating life of the heater can be long and the production cost can be reduced.

Moreover, the joint member is coated with the conductive layer and thereby fixed to the plate member, and therefore, contact of the conductive layer and the joint member is good and the durability is enhanced without using a screw or the like that is easily damaged by the heater heat and the heater weight, and the operating life of the heater becomes long.

Furthermore, when the heater power-supply component includes the conductive member made of conductive ceramics having a concave portion in one end thereof that the projecting portion of the joint member is inserted into and connected with and having a power terminal in another end thereof to be connected to a power source and the protection layer made of insulating ceramics provided on an outer surface of the conductive member, the conductive member made of conductive ceramics is protected from the process gas by the protection layer made of insulating ceramics.

And, when the conductive member has a rod shape, there is a sufficient distance between the power terminal that is the junction with a conductive wire or the like and the heater main body. Therefore, the temperature is low at the junction with a conductive wire or the like. Degradation of such a member as a crimping terminal or a bolt or a screw or a nut or the like which is used in the connection, and scattering of particles due thereto, can be suppressed.

Furthermore, when a distance from an outermost part of an end face in the one end of the heater power-supply component that the joint member is connected with to the concave portion therein is 3 mm or more, in the case of using a gas reacting with the conductive ceramics at a high temperature as a process gas, the process gas is difficult to reach the conductive ceramics of the projecting portion and the concave portion by performing the connection so that the protection layer on the end face in the one end of the heater power-supply component connected with the joint member and the coating layer of the ceramic heater main body are attached firmly. Therefore, the conductive ceramics of the projecting portion and the concave portion can be prevented from being wasted.

In the above case, it is preferable that the heater power-supply component has a guard portion in the one end that the joint member is connected with.

When the conductive member of the heater power-supply component has a guard portion in the one end that the joint member is connected with, the end face of the one end that the joint member is connected with can be broadened and it is easy to set a distance from an outermost part of the end face to the concave portion therein to be 3 mm or more. Moreover, by existence of such a guard portion, blocking effect against the process gas is more improved.

Moreover, when the portion having the power terminal except the guard portion has a thin rod shape, amount of heat to outflow to the outside through the heater power-supply component from the heater can be small, and therefore, the heating uniformity of the heater can be improved.

And, it is preferable that a male screw is formed on the projecting portion, a female screw is formed on the concave portion of the conductive member, the male screw is screwed together to the female screw, and thereby the projecting portion of the joint member is connected to the conductive member.

When the connection of the projecting portion of the joint member with the conductive member is performed by forming a male screw on the projecting portion of the joint member and by forming a female screw on the concave portion of the conductive member and screwing together the male screw to the female screw, the member exchange is easy in the case that the conductive member or the protection layer formed thereon is damaged. Assembly thereof is easy and space is not wasted in storage or transportation, and therefore the heater can be high in convenience.

Moreover, the female screw and male screw are not degraded with being exposed directly to a reactive atmosphere. Furthermore, even when the heater power-supply component or particularly a protection layer provided thereon is damaged, only the component can be exchanged. Therefore, the operating life of the heater can be long and the production cost can be reduced.

Moreover, it is preferable that the conductive member is made of any one of, graphite, graphite coated with pyrolytic graphite containing boron and/or boron carbide on an outer surface thereof, sintered silicon carbide, sintered boron carbide, tantalum, tungsten, molybdenum, inconel, nickel, and stainless.

When as the conductive member, any one of, graphite, graphite coated with pyrolytic graphite containing boron and/or boron carbide on an outer surface thereof, sintered silicon carbide, sintered boron carbide, tantalum, tungsten, molybdenum, inconel, nickel, and stainless, is used, conductivity thereof is high and additionally melting point thereof is high. Therefore, the heater becomes applicable to a heating process of 1000° C. or more. In particular, when any one of graphite and sintered silicon carbide and sintered boron carbide is used, heat resistance thereof is excellent, and additionally the protection layer is coated on the outer surface thereof, and therefore, there is no corrosion due to the process gas or no scattering of impurities and the heater becomes stably applicable to heating process in which high purity is required. Moreover, graphite is more preferable because it is relatively inexpensive and easy to be processed.

Furthermore, it is preferable that the conductive member is surrounded by a tubular member made of insulating ceramics.

When the conductive member is surrounded by a tubular member made of insulating ceramics, scattering of impurities or particles from the conductive member can be suppressed, and the conductive member is insulated from a peripheral member thereof. Therefore, electric discharge between the conductive member and a peripheral member can be prevented.

Moreover, in the case that damage is caused in the tubular member, it is sufficient that only the member is exchanged, and therefore, it becomes possible that the heater has a long operating life.

Furthermore, in the above case, it is possible that the tubular member has a bottom in one end thereof and is provided with a through-hole in a central part of the bottom, a bottom face of the bottom is in contact with a heater main body, the projecting portion of the joint member is inserted into the through-hole thereof, further the conductive member is inserted into the tubular member, and thereby the tubular member surrounds the conductive member.

When the surrounding by the tubular member is performed by forming a bottom in one end of the tubular member made of insulating ceramics and by providing a through-hole in a central part of the bottom and by inserting the projecting portion of the joint member into the through-hole thereof and by contacting a bottom face of the bottom with a heater main body and further by inserting and fixing the projecting portion into the conductive member, the surrounding of the joint member and the conductive member by the insulating ceramics in the vicinity of the heater main body can be certainly performed. Heater damage due to degradation by the heater heat or the like, or scattering of impurities or particles, can be suppressed effectively.

Furthermore, it is preferable that a protection layer made of insulating ceramics is formed on the conductive member.

When the conductive member that a protection layer made of insulating ceramics is formed on a surface thereof is used, scattering of impurities or particles from the conductive member is more suppressed and the conductive member is insulated from a peripheral member thereof in the heater. Therefore, electric discharge between the conductive member and a peripheral member can be prevented.

In particular, when the protection layer on the conductive member is entirely formed except the concave portion and a portion for being connected to a conductive wire or the like and when the projecting portion and the concave portion are connected so that the protection layer is attached firmly to the heater main body, the heater becomes being capable of being used under an atmosphere being reactive with the conductive layer or the joint member or the conductive member. Heater damage due to degradation by the heater heat or the like, or scattering of impurities or particles, can be suppressed effectively.

In particular, in this case, it is preferable that the conductive member is made of graphite or sintered silicon carbide or sintered boron carbide that is conductive ceramics and the protection layer made of insulating ceramics is formed thereon because at a higher temperature, the heater is stable and scattering of impurities is small.

Moreover, it is preferable that the coating layer, the tubular member, or the protection layer on the conductive member, is made of any one of, pyrolytic boron nitride, pyrolytic boron nitride containing carbon, pyrolytic boron nitride containing silicon, and pyrolytic boron nitride containing aluminum.

When any one of pyrolytic boron nitride and pyrolytic boron nitride containing carbon and pyrolytic boron nitride containing silicon and pyrolytic boron nitride containing aluminum is used as the coating layer or the tubular member or the protection layer on the conductive member, the conductive member can be protected from corrosion due to the process gas, and also, it is easily produced by chemical vapor deposition method. And, even when used at a high temperature, the heater is stable and causes no scattering of impurities, and the heater also becomes applicable to heating process in which high purity is required.

Here, in the case that the coating layer or the tubular member or the protection layer on the conductive member is made of pyrolytic boron nitride containing carbon or pyrolytic boron nitride containing silicon or pyrolytic boron nitride containing aluminum, the resistivity becomes smaller as the carbon content or the silicon content or the aluminum content becomes larger. Therefore, with respect to the coating layer, the carbon content or the silicon content or the aluminum content is required to be suppressed to amount by which insulation can be held at gaps of the heater pattern or between the heater pattern and the object to be heated. And, with respect to the tubular member or the protection layer on the conductive member, it is required to be suppressed to amount by which insulation can be held between the conductive member and a peripheral member thereof.

Moreover, the heater power-supply component of the present invention is not necessarily limited to such a component as connected to the ceramic heater as described above. The present invention provides a heater power-supply component comprising: at least

a conductive member with a rod shape made of conductive ceramics having a concave portion in one end thereof that a joint terminal of a ceramic heater main body can be inserted into and connected with and having a power terminal in another end thereof to be connected to a power source; and

a protection layer made of insulating ceramics provided on an outer surface of the conductive member; and

wherein a distance from an outermost part of an end face in the one end that the joint terminal is connected with to the concave portion therein is 3 mm or more.

When the heater power-supply component includes the conductive member made of conductive ceramics having a concave portion in one end thereof that the joint terminal of the ceramic heater main body can be inserted into and connected with and having a power terminal in another end thereof to be connected to a power source and the protection layer made of insulating ceramics provided on an outer surface of the conductive member, the conductive member made of conductive ceramics is protected from the process gas by the protection layer made of insulating ceramics.

And, when the conductive member has a rod shape, there is a sufficient distance between the power terminal that is the junction with a conductive wire or the like and the heater main body. Therefore, the temperature is low at the junction with a conductive wire or the like. Degradation of such a member as a crimping terminal or a bolt or a screw or a nut or the like which is used in the connection, and scattering of particles due thereto, can be suppressed.

Furthermore, when a distance from an outermost part of an end face in the one end that the joint terminal is connected with to the concave portion therein is 3 mm or more, in the case of using a gas reacting with the conductive ceramics at a high temperature as the process gas, the process gas is difficult to reach the conductive ceramics of the concave portion by performing the connection so that the protection layer on the end face in the one end of the heater power-supply component to be connected with the joint terminal and the coating layer of the ceramic heater main body are attached firmly. Therefore, the conductive ceramics of the concave portion is not wasted.

Moreover, because the heater power-supply component is a separate component from the heater main body, in the case that the heater power-supply component or particularly the protection layer provided therein is damaged, it is sufficient that only the component is exchanged. Therefore, it becomes possible that the operating life of the heater becomes long and that production cost is reduced.

In the above case, it is preferable that the heater power-supply component has a guard portion in the one end that the joint terminal can be connected with.

When the conductive member of the heater power-supply component has a guard portion in the one end that the joint terminal can be connected with, the end face of the one end that the joint terminal is connected with can be broadened and it is easy to set a distance from an outermost part of an end face in the one end that the joint terminal can be connected with to the concave portion therein to be 3 mm or more. Moreover, by existence of such a guard portion, blocking effect against the process gas is more improved.

Moreover, when the portion having the power terminal except the guard portion has a thin rod shape, amount of heat to outflow to the outside through the heater power-supply component from the heater can be small, and therefore, the heating uniformity of the heater can be improved.

Furthermore, it is preferable that the conductive member of the heater power-supply component is made of any one of, graphite, sintered silicon carbide, and sintered boron carbide.

When any one of graphite and sintered silicon carbide and sintered boron carbide is used as the conductive member, heat resistance thereof is excellent, and additionally, the protection layer is coated on the outer surface thereof. Therefore, there is no corrosion due to the process gas or no scattering of impurities, and therefore, the heater becomes stably applicable to heating process in which high purity is required. In particular, graphite is more preferable because it is relatively inexpensive and easy to be processed.

Moreover, it is preferable that the protection layer of the heater power-supply component is made of any one of, pyrolytic boron nitride, pyrolytic boron nitride containing carbon, pyrolytic boron nitride containing silicon, and pyrolytic boron nitride containing aluminum.

When the protection layer is made of any one of pyrolytic boron nitride and pyrolytic boron nitride containing carbon and pyrolytic boron nitride containing silicon and pyrolytic boron nitride containing aluminum, the conductive member can be protected from corrosion due to the process gas, and also, it is easily produced by chemical vapor deposition method. And, even when used at a high temperature, the heater is stable and causes no scattering of impurities, and therefore, the heater also becomes applicable to heating process in which high purity is required.

Here, in the case that the protection layer is made of pyrolytic boron nitride containing carbon or pyrolytic boron nitride containing silicon or pyrolytic boron nitride containing aluminum, the resistivity becomes smaller as the carbon content or the silicon content or the aluminum content becomes larger. Therefore, the carbon content or the silicon content or the aluminum content is required to be suppressed to amount by which insulation can be held between the power-supply component and a peripheral member thereof.

Furthermore, it is preferable that on the concave portion, a female screw is formed.

When the connection between the heater main body and the heater power-supply component is performed by forming a female screw on the concave portion of the heater power-supply component and by forming a male screw on the joint terminal and by screwing together the male screw to the female screw, the portions of the female screw and the male screw are not degraded with being exposed directly to a reactive atmosphere. Moreover, even when the heater power-supply component or particularly a protection layer provided therein is damaged, only the component can be exchanged. Therefore, the operating life of the heater can be long and the production cost can be reduced.

Assembly thereof is easy and space is not wasted in storage or transportation, and therefore the heater can be high in convenience.

As described above, according to the present invention, it becomes possible to produce a ceramic heater by which an object to be heated being put directly thereon can be heated uniformly and of which heating efficiency is high and in which the heater main body is not large in size and is compact and difficult to be damaged and scattering of impurities or particles is small and which has a long operating life and is inexpensive.

In particular, when the portion of the joint member that is connected with the plate member and that in use the heater heat is large and also the heater weight is drastically loaded in is connected by press-fit, a screw is not used and therefore a trouble such as breaking or scattering of impurities or particles can be prevented. On the other hand, when the connection of the joint member to the conductive member is performed by screwing-together with screws, it becomes easy to exchange the members in the case that the conductive member or a protection layer formed thereon is damaged, and assembly of the heater is easy and space is not wasted in storage or transportation, and therefore the ceramic heater can be high in convenience.

Moreover, in the heater power-supply component, a distance from an outermost part of an end face in the one end that the joint terminal can be connected with to the concave portion therein is 3 mm or more, and therefore by performing the connection so that the protection layer on the end face in the one end of the heater power-supply component and the coating layer of the ceramic heater main body are attached firmly, the gap between the protection layer and the coating layer can be completely blocked from the process gas. Therefore, the conductive ceramics of the joint terminal and the concave portion is not wasted by invasion of the process gas, and the operating life of the heater is very long.

### BRIEF EXPLANATION OF THE DRAWINGS

FIG. 1 is a cross-section view showing an example of a ceramic heater of the present invention.

FIG. 2 is a plan view showing an example of a plate member and a joint member in the ceramic heater of the present invention.

FIG. 3 is a side view showing an example of a plate member and a joint member in the ceramic heater of the present invention.

FIG. 4 is a plan view showing an example of a heater pattern in the ceramic heater of the present invention.

FIG. 5 is a plan view showing an example of a back surface in the ceramic heater of the present invention.

FIG. 6 is a cross-section view showing an example for connecting a conductive member with the joint member in the ceramic heater of the present invention.

FIG. 7 is a cross-section view showing an example that the conductive member of the ceramic heater of the present invention is connected.

FIG. 8 is a cross-section view showing another example for connecting a conductive member with the joint member in the ceramic heater of the present invention.

FIG. 9 is a cross section view showing another example that the conductive member of the ceramic heater of the present invention is connected.

FIG. 10 is a plan view showing an example of a zone division of a heater pattern of a ceramic heater having two-zone system according to a conventional technique.

FIG. 11 is a plan view showing an example of a plate member and a rod member according to a conventional technique.

FIG. 12 is a cross-section view showing an example of another shape of the ceramic heater of the present invention.

FIG. 13 is a cross-section view showing an example of the heater power-supply component of the present invention.

FIG. 14 is a plan view showing an example of a plate member and a joint member in the ceramic heater of the present invention.

### DETAILED DESCRIPTION OF THE PREFERRED EMBODIMENTS

Conventionally, in the case of producing a heater having high durability which causes no scattering of impurities in heating and which is applicable to heating process in which high purity is required, positions in which graphite rod members are provided by screws have to be outside the region on the heater on which an object to be heated is put. Therefore, the heater becomes large in size. Moreover, with respect to the heater having a structure in which the heater main body and the graphite screw and the graphite rod member are integrally coated with a coating layer made of insulating ceramics, there have been problems that in the case of damaging the graphite rod member or the coating layer coating it, the whole of the heater has to be exchanged and therefore the operating life of the heater becomes short and additionally the cost is high.

Then, the present inventors have investigated thoroughly. They have found that by the following ceramic heater, an object to be heated being put directly on the ceramic heater can be heated uniformly and heating efficiency thereof is high and the heater main body is not large in size and is compact and scattering of impurities or particles is small and the heater is difficult to be damaged and has a long operating life and is inexpensive. And, the present invention has been accomplished.

The present invention provides a ceramic heater comprising: at least

a plate member made of insulating ceramics in which one or more pair(s) of through-holes are formed;

a conductive layer made of conductive ceramics formed on the plate member; and

a coating layer made of insulating ceramics formed on the conductive layer;

wherein a joint member made of conductive ceramics is inserted into the through-hole of the plate member;

an end face of the joint member inserted into the through-hole has a same plane with a main surface of the plate member on which the conductive layer is formed;

the joint member is coated with the conductive layer and thereby fixed to the plate member and also connected with the conductive layer having a heater pattern formed on a main surface of the plate member; and

a side of the joint member opposite to a side thereof inserted into the through-hole of the plate member projects from the plate member and the projecting portion constitutes a terminal on which the coating layer is not formed.

And, when the portion of the joint member that is connected with the plate member and that in use the heater heat is large and also the heater weight is drastically loaded in is connected by press-fit, a screw is not used and therefore a trouble such as breaking or scattering of impurities or particles can be prevented. On the other hand, when the connection of the joint member to the conductive member is performed by screwing-together with screws, it becomes easy to exchange the members in the case that the conductive member or a protection layer formed thereon is damaged, and assembly of the heater is easy and space is not wasted in storage or transportation, and therefore the ceramic heater can be high in convenience.

In particular, when a distance from an outermost part of an end face in the one end of the heater power-supply component that the projecting portion of the joint member is connected with to the concave portion therein is 3 mm or more, by performing the connection so that the protection layer on the end face in the one end of the heater power-supply component and the coating layer of the ceramic heater main body are attached firmly, the gap between the protection layer and the coating layer is made to completely disappear, and therefore blocking effect from the process gas can be sufficiently enlarged. Therefore, the conductive ceramics of the projecting portion and the concave portion is not wasted by invasion of the process gas, and furthermore, the operating life of the heater becomes long.

Hereinafter, embodiments according to the present invention will be explained in detail with reference to the appended drawings. However, the present invention is not limited thereto.

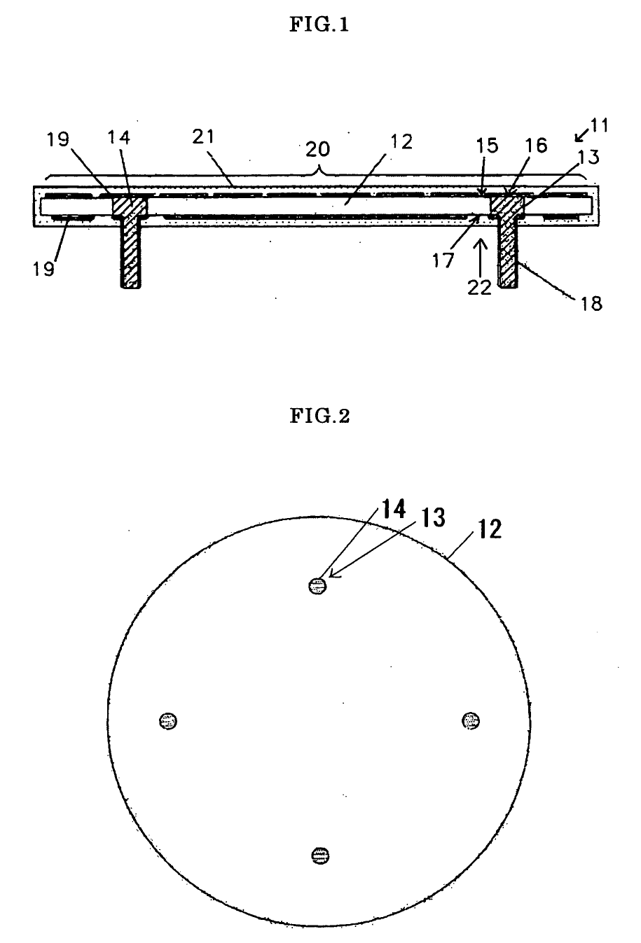

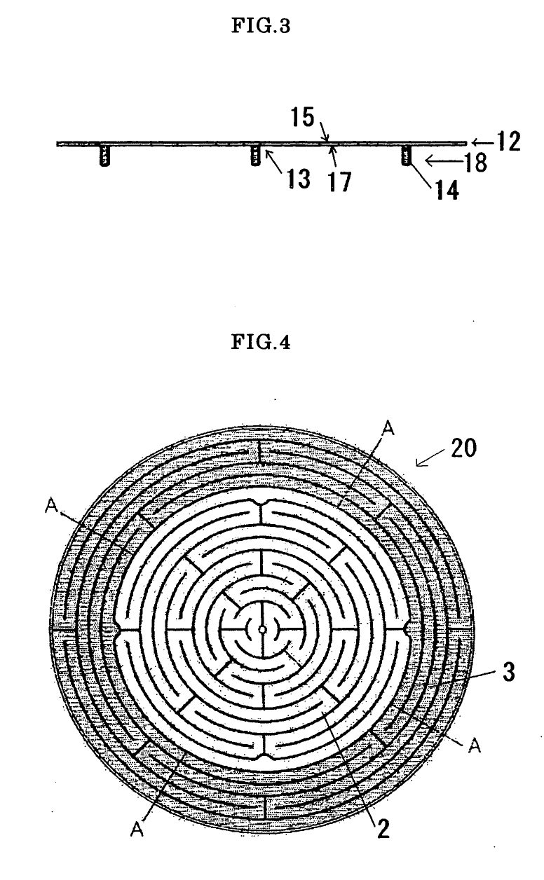

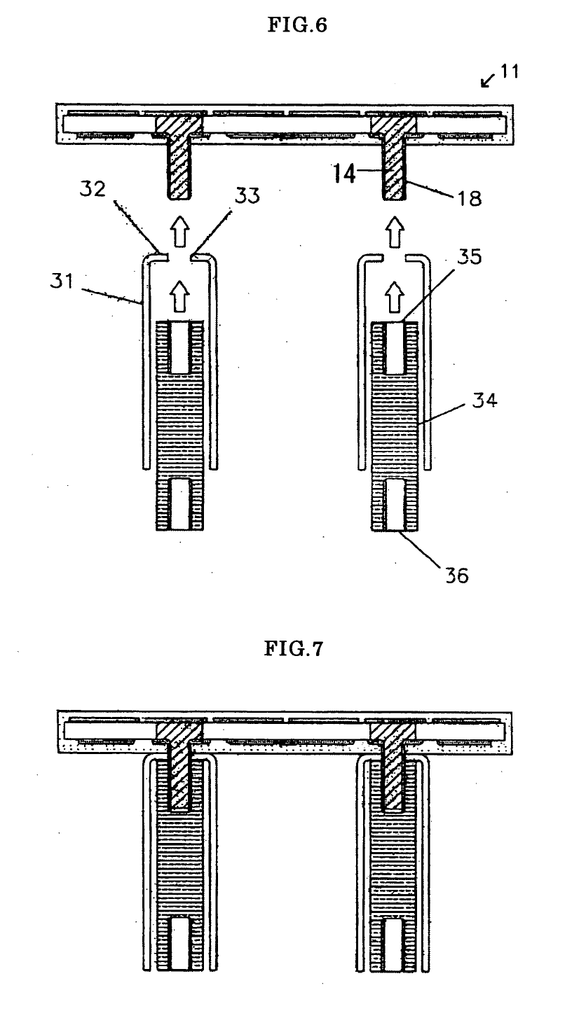

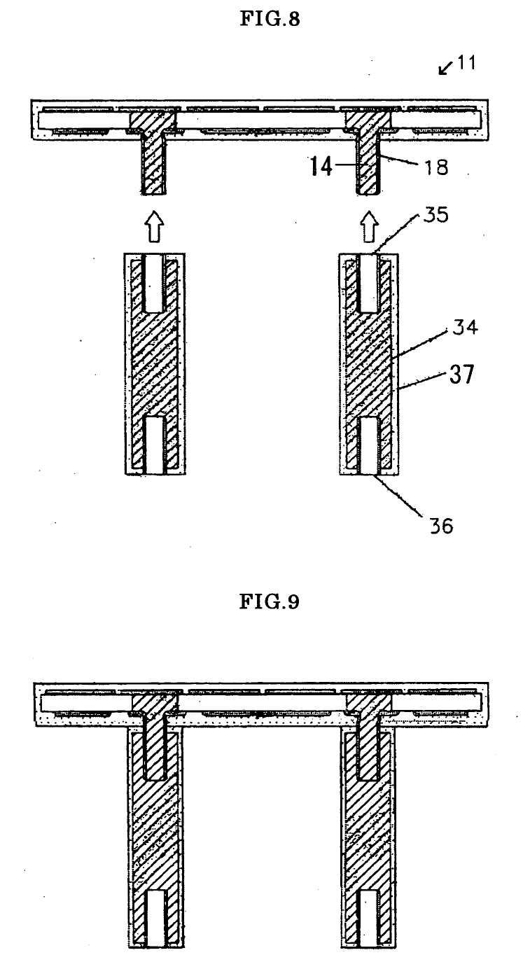

FIG. 1 is a cross-section view showing an example of a ceramic heater of the present invention. FIGS. 2 and 3 are views showing an example of a plate member and a joint member in the ceramic heater of the present invention. FIGS. 6 and 8 are views showing an example for connecting a conductive member with the joint member in the ceramic heater of the present invention.

The ceramic heater according to the present invention is a ceramic heater 11 comprising: at least

a plate member 12 made of insulating ceramics in which one or more pair(s) of through-holes 13 are formed;

a conductive layer 19 made of conductive ceramics formed on the plate member 12; and

a coating layer 21 made of insulating ceramics formed on the conductive layer 19;

wherein a joint member 14 made of conductive ceramics is inserted into the through-hole 13 of the plate member 12;

an end face 16 of the joint member 14 inserted into the through-hole 13 has a same plane with a main surface 15 of the plate member 12 on which the conductive layer 19 is formed;

the joint member 14 is coated with the conductive layer 19 and thereby fixed to the plate member 12 and also connected with the conductive layer 19 having a heater pattern 20 formed on a main surface 15 of the plate member 12; and

a side of the joint member 14 opposite to a side thereof inserted into the through-hole 13 of the plate member 12 projects from the plate member 12 and the projecting portion 18 constitutes a terminal on which the coating layer 21 is not formed.

When an end face 16 of the joint member has a same plane with a main surface 15 of the plate member 12 and is connected with the conductive layer 19 having a heater pattern 20 formed on the main surface 15 of the plate member 12, it is not necessary the positions in which the joint members 14 are provided are made to be outside the region on the plate member 12 on which an object to be heated is put, and can be set to discretionary positions inside the region. Therefore, it becomes possible that the ceramic heater is smaller in size than a conventional heater and is flat without projection on the heating surface of the heater.

In addition, in the ceramic heater, by the heater pattern 20 formed on the same plane, an object to be heated being put directly on the flat heater can be uniformly heated with high heating efficiency. Moreover, for further accomplishing heat uniformity, as FIG. 1, the heater pattern 20 is also formed on the end face 16 of the joint member.

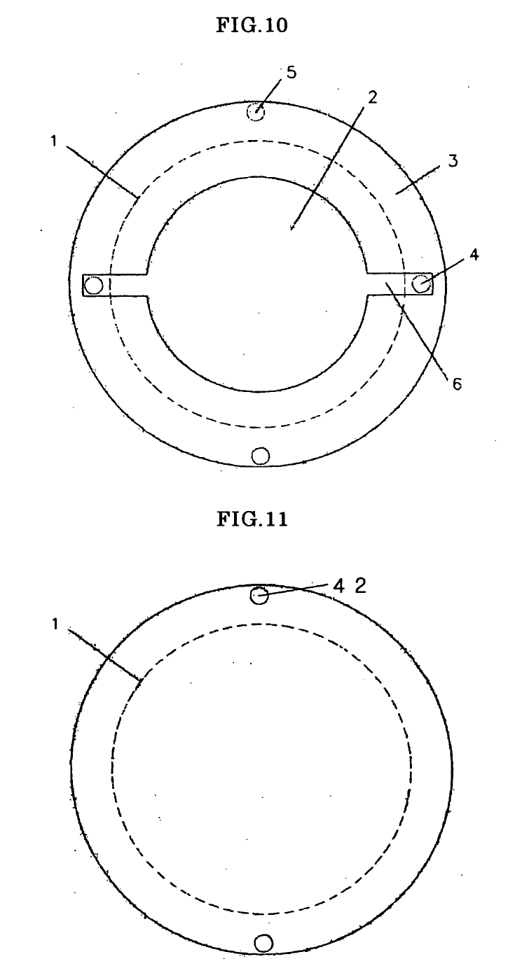

Furthermore, in the case that the ceramic heater according to the present invention has two-zone system, the heater is difficult from a conventional heater as shown in FIG. 10, and the joint members 14 to be connected to the first heating region 2 can be provided in the first heating region 2. Therefore, it is not necessary that the conductive pathways connecting the first heating region 2 and the joint members 14 are provided in the second heating region 3. Therefore, in the case of two-zone system, it is possible that the ceramic heater can have better heating uniformity (see, FIG. 4).

Moreover, when the joint member 14 projects from the plate member 12 and the projecting portion 18 constitutes a terminal on which the coating layer 21 is not formed, the joint member can be connected to a conductive member having a concave portion, for example, a conductive member 34 with a rod shape as shown in FIGS. 6 and 8, and the conductive member can be exchanged if damaged. Therefore, the operating life of the heater becomes long.

Furthermore, because the joint member 14 is coated with the conductive layer 19 and thereby fixed to the plate member 12, contact of the conductive layer 19 and the joint member 14 is good and the durability is enhanced without using a screw or the like that is easily damaged by the heater heat and the heater weight and so forth, and the operating life of the heater can be long.

Moreover, it is preferable that the joint member 14 is pressed-fit into the through-hole 13 of the plate member 12. Thereby, a screw that causes a trouble of breaking due to the magnitude of the heater heat and the large load in heater weight and so forth is not used for connecting the plate member and the joint member. Therefore, the contact of the conductive layer and the joint member can be maintained to be good for a long time, and the ceramic heater comes to be capable of being used stably and to have a long operating life.

Furthermore, when the joint member 14 is pressed-fit into the through-hole 13 of the plate member 12, the joint member 14 is not required to be thick for the purpose of preventing a trouble in screw ridge and therefore can be small in cross-section area thereof. Therefore, amount of heat to outflow to the outside can be suppressed to small and the object to be heated can be heated uniformly with higher heating efficiency. In addition, because it is not necessary to use a bolt and a nut being a source origin of particles, there is no scattering of impurities and the heater is applicable to heating process in which high purity is required. Furthermore, in this case, it is preferable that after the press-fit, flat-surface processing is performed by flat-surface grinding of the main surface or the like so that the end face 16 of the joint member and the main surface 15 of the plate member have an accurately same plane.

As shown in FIGS. 6 and 8, it is preferable that the projecting portion 18 of the joint member 14 is inserted into a concave portion 35 provided in one end of a conductive member 34 with a rod shape made of conductive ceramics that is a separate member from the joint member 14, and thereby connected with the conductive member (see, FIGS. 7 and 9). Thereby, a power terminal 36 for being connected with a conductive wire or the like is provided in the other end opposite to the one end in which the concave portion 35 of the conductive member with a rod shape is provided, and thereby, there is a sufficient distance between the power terminal and the heater main body. Therefore, the temperature is low at the power terminal 36 for being connected with the conductive wire or the like. Degradation due to the heater heat of such a member as a crimping terminal or a bolt or a screw or a nut or the like which is used in the connection, and scattering of particles due thereto, can be suppressed.

Moreover, because the conductive member 34 is a separate member from the heater main body, in the case that the conductive member 34 is damaged, it is sufficient that only the member is exchanged, and therefore, the heater can come to have a long operating life.

It is preferable that a male screw is formed on the projecting portion 18, a female screw is formed on the concave portion 35 of the conductive member 34, the male screw is screwed together to the female screw, and thereby the projecting portion 18 of the joint member 14 is connected to the conductive member. Thereby, the electric connection can be assured, and the member exchange is easy in the case that the conductive member or the protection layer formed thereon is damaged. Assembly thereof is easy and space is not wasted in storage or transportation, and therefore the heater can be high in convenience.

When the joint member 14 that is connected with the plate member and that in use the heater heat is large and also the heater weight is drastically loaded in is connected by press-fit, a screw is not used and therefore a trouble such as breaking or scattering of impurities or particles can be prevented. On the other hand, when the connection of the joint member to the conductive member is performed by screwing-together with screws, the members are difficult to be damaged, and the member exchange is easy in the case that the conductive member 34 or the protection layer formed thereon is damaged if any possibility, and assembly of the heater is easy and space is not wasted in storage or transportation, and therefore the ceramic heater can be high in convenience.

The joint member 14 is sufficient as long as made of conductive ceramics, and however is preferably made of any one of, graphite, sintered silicon carbide, and sintered boron carbide. Thereby, the joint member becomes excellent in heat resistance and additionally the outer face in the upper side thereof are coated with the conductive layer 19 and the coating layer 21, and therefore, there is no scattering of impurities and therefore the heater is applicable to heating process in which high purity is required. In particular, graphite is more preferable because it is relatively inexpensive and easy to be processed.

It is preferable that the shape of the joint member 14 is a bolt shape having a cylindrical shape as shown in FIGS. 1, 6, 8, and 12. However, the shape is not limited thereto and is sufficient as long as a shape being capable of being inserted into the through-hole 13 and fixed. The diameter of the joint member 14 is not particularly limited. However, the diameter of the portion inserted to the through-hole 13 may be 3-20 mm, and more preferably, 8-14 mm. If the diameter is larger than 3 mm, the joint member is difficult to break. If the diameter is smaller than 20 mm, outflow of heat to the outside from the joint member 14 is small and temperature distribution of the heater becomes uniform.

Moreover, the plate member 12 is sufficient as long as being made of insulating ceramics in which one or more pair(s) of through-holes 13 are formed and functioning as a supporting substrate on which the heater pattern 20 is formed. However, it is preferable that the plate member is made of any one of pyrolytic boron nitride, pyrolytic boron nitride containing carbon, pyrolytic boron nitride containing silicon, and pyrolytic boron nitride containing aluminum. Thereby, the plate member 12 can be produced by chemical vapor deposition method and has a high insulating property and there is no scattering of impurities due to use at a high temperature, and therefore is applicable to heating process in which high purity is required.

In particular, the plate member can be also used stably in a high-temperature process in the vicinity of 1500° C. and additionally at a rapidly rising or falling temperature of 100° C./min or more. It is preferable that thickness of the plate member 12 is 1-5 mm, and more preferably, 2-4 mm. In the case that the thickness of the plate member 12 is thinner than 1 mm, warpage is not caused. Moreover, in the case that the thickness is thinner than 5 mm, the difference between thermal expansion amount in the thickness direction of the plate member 12 and thermal expansion amount of the joint member 14 does not become too large, and at the press-fit part, crack or delamination is not generated in the conductive layer 19 made of conductive ceramics or the coating layer 21.

In addition, in the case that the plate member 12 is made of pyrolytic boron nitride containing carbon or pyrolytic boron nitride containing silicon or pyrolytic boron nitride containing aluminum, resistivity of the plate member becomes smaller as the carbon content or the silicon content or the aluminum content becomes larger. It is necessary that the carbon content or the silicon content or the aluminum content is suppressed to amount by which insulation can be held at gaps of the heater pattern.

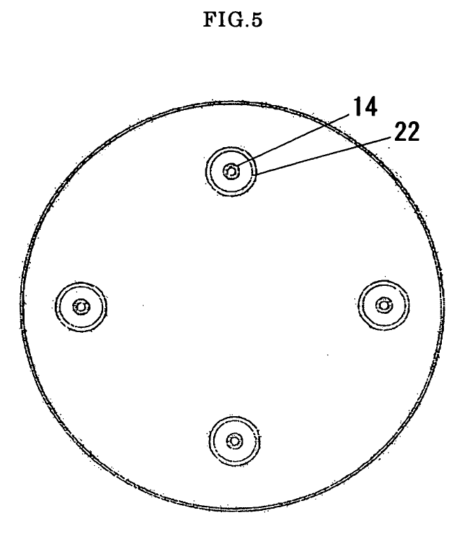

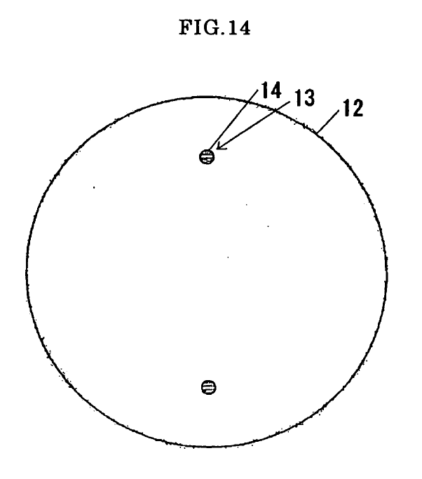

Moreover, it is preferable that the shape of the plate member 12 is a disc-like shape as FIGS. 2, 4, and 14 for supporting a semiconductor wafer having a circular shape with a large diameter as an object to be heated. However, it may be a polygonal plate shape according to need. Moreover, the through-holes 13 are formed by one or more pair(s). However, for example, in the case of the heater having a two-zone system, two pairs are formed as FIGS. 2 and 5. The shape of the through-hole 13 is not particularly limited as long as a shape being capable of inserting the joint member 14 thereinto and fixing it thereto. However, a circular shape being capable of pressing-fit and fixing the joint member 14 with a cylindrical shape thereto is preferable.

Furthermore, the conductive layer 19 is made of conductive ceramics and coats and fixes the plate member 12 and the joint member 14 inserted into the through-hole 13 therein. Thereby, the joint member 14 and the plate member 12 can be fixed, and the electric contact of the conductive layer and the joint member can be good.

It is preferable that the conductive layer 19 is made of any one of pyrolytic graphite and pyrolytic graphite containing boron and/or boron carbide. Thereby, the heater can be stably used until a high temperature, and the conductive layer is easier to be processed than metal foil or rolled circuit and therefore it becomes easy that as the heater pattern having meandering pattern, width and thickness thereof are changed and thereby to make a discretionary temperature gradient therein or to make a heating distribution therein according to the heat environment to uniform heat. Furthermore, by using chemical vapor deposition method, the thickness of the conductive layer can be more uniform, compared to a method of coating a conductive paste by screen-printing.

The thickness of the conductive layer 19 is not particularly limited. However, it is desirable that the thickness is 10-300 μm and particularly 30-150 μm. It is sufficient that an appropriate thickness is selected well-considering the relation of the electric capacity or the shape of the heater pattern 20 for making the heater temperature reach an objective temperature and uniformizing heat.

The heater pattern 20 can be formed, for example, by machining. However, as shown in FIG. 1, the heater pattern 20 can be formed on the main surface 15 of the plate member of the same plane made by the end face 16 of the joint member 14 opposite to the side having the projecting portion 18 therein and the main surface 15 of the plate member. In this case, the heater pattern can also be formed on the end face 16 of the joint member as described above. By such a heater pattern 20, an object to be heated can be heated uniformly with high heating efficiency.

In this case, as well as on the main surface 15 of the plate member, the heater pattern 20 may be formed on a main surface 17 opposite to the main surface 15, or formed on both of the main surface 15 and the main surface 17. The heater pattern can be designed according to flatness for putting an object to be heated and necessary heat amount and so forth.

Here, in the main surface on which the heater pattern 20 is not formed, it is necessary that the joint members are electrically insulated not to be short-circuited to each other. For example, as shown in FIG. 5 and FIG. 1, the electrical insulating can be performed by forming a removal part of the conductive layer by providing a groove 22 in the back surface thereof or the like.

For example, as shown in FIG. 4, the heater pattern 20 is formed as a two-zone system so that one pair of the joint members can supply current in the pattern forming the first heating region 2 shown as the inner white part and so that the other pair of the joint members 14 can supply current in the pattern forming the second heating region 3 shown as the outer gray part.

The conductive member 34 is sufficient as long as being provided with a concave portion 35 into which the projecting portion 18 of the joint member 14 is inserted. However, it is preferable that the conductive member is made of any one of, graphite, graphite coated with pyrolytic graphite containing boron and/or boron carbide on an outer surface thereof, conductive sintered silicon carbide, conductive sintered boron carbide, tantalum, tungsten, molybdenum, inconel, nickel, and stainless.

Thereby, the heater becomes applicable to a heating process of 1000° C. or more because conductivity of the conductive member 34 is high and additionally melting point thereof is high. In particular, graphite is more preferable because it is relatively inexpensive and easy to be processed.

It is preferable that the conductive member 34 is surrounded by a tubular member 31 made of insulating ceramics as shown in FIG. 6. Thereby, in the heater, scattering of impurities or particles from the conductive member can be suppressed, and the conductive member is insulated from a peripheral member thereof. Therefore, electric discharge between the conductive member and a peripheral member can be prevented.

Moreover, in the case that damage is caused in the tubular member 31, it is sufficient that only the member is exchanged, and therefore, it becomes possible that the heater has a long operating life.

It is possible that the tubular member 31 has a bottom 32 in one end thereof and is provided with a through-hole 33 in a central part of the bottom, a bottom face of the bottom 32 is in contact with a heater main body, the projecting portion 18 of the joint member 14 is inserted into the through-hole 33, further the conductive member 34 is inserted into the tubular member, and thereby the tubular member can surround the conductive member 34. Thereby, the surrounding of the conductive bodies by the insulating ceramics in the vicinity of the heater main body can be certainly performed. Scattering of impurities or particles due to degradation by the heater heat can be suppressed certainly.

Moreover, as shown in FIG. 8, it is preferable that a protection layer 37 made of insulating ceramics is formed on the conductive member 34. Thereby, scattering of impurities or particles from the conductive member 34 is suppressed and the conductive member 34 is insulated from a peripheral member thereof in the heater. Therefore, electric discharge between the conductive member 34 and a peripheral member thereof can be prevented.

In particular, when the protection layer 37 on the conductive member is entirely formed except the concave portion 35 and a portion 36 for being connected to a conductive wire or the like and when the concave portion 35 and the projecting portion 18 are connected so that the protection layer 37 is attached firmly to the heater main body, the heater becomes being capable of being used under an atmosphere being reactive with the joint member 14 or the conductive member 34. Electric discharge, heater damage, or scattering of impurities or particles which is caused by corrosion by the reactive atmosphere can be suppressed effectively.

In particular, in this case, it is preferable that the conductive member is made of graphite or sintered silicon carbide or sintered boron carbide that is conductive ceramics and the protection layer made of insulating ceramics is formed thereon because at a higher temperature, the conductive member is stable and scattering of impurities is small.

It is preferable that the coating layer 21, the tubular member 31, or the protection layer 37 on the conductive member, is made of any one of, pyrolytic boron nitride, pyrolytic boron nitride containing carbon, pyrolytic boron nitride containing silicon, and pyrolytic boron nitride containing aluminum. As described above, they can be easily produced by chemical vapor deposition method. And, even when used at a high temperature, the heater is stable and causes no scattering of impurities, and therefore, the heater also becomes applicable to heating process in which high purity is required.

Here, in the case that the coating layer 21 or the tubular member 31 or the protection layer 37 on the conductive member is made of pyrolytic boron nitride containing carbon or pyrolytic boron nitride containing silicon or pyrolytic boron nitride containing aluminum, the resistivity becomes smaller as the carbon content or the silicon content or the aluminum content becomes larger.

Therefore, with respect to the coating layer 21, the carbon content or the silicon content or the aluminum content is required to be suppressed to amount by which insulation can be held at gaps of the heater pattern or between the heater pattern and the object to be heated. And, with respect to the tubular member 31 or the protection layer 37 on the conductive member, it is required to be suppressed to amount by which insulation can be held between the conductive member and a peripheral member thereof.

In the ceramic heater according to the present invention as described above, on the surface side on which the end face 16 of the joint member 14 has the same plane with the main surface 15 of the plate member 12 and on which the heater pattern 20 is formed, an object to be heated such as a semiconductor wafer with a large diameter is directly put, and electric power is supplied from the power-supply terminal 18, and thereby, the objected to be heated can be heated uniformly with high heating efficiency although the heater main body does not become large in size and has a compact structure. And, because scattering of impurities or particles is small, contamination to the object to be heated is small and the operating life of the heater is long.

The ceramic heater according to the present invention as described above can be produced by a method for producing a ceramic heater 11, comprising steps of:

forming one or more pair(s) of through-holes 13 in a plate member 12;

forming a conductive layer 19 on the plate member 12; and then

forming a coating layer 21 on the conductive layer 19;

wherein a joint member 14 is inserted into the through-hole 13 so that an end face 16 of the joint member 14 has a same plane with a main surface 15 of the plate member and so that a side of the joint member 14 opposite to a side thereof inserted into the through-hole 13 projects from the plate member 12; then

the conductive layer 19 is formed so that the joint member 14 and the plate member 12 are integrally coated therewith and thereby the joint member 14 and the plate member 12 are firmly fixed;

a heater pattern is formed by processing the conductive layer 19 on a main surface 15, 17 of the plate member 12; and then

the coating layer 21 is formed so that the plate member 12 and the joint member 14 and the conductive layer 19 are integrally coated therewith except the projecting portion 18 of the joint member 14.

Thereby, the ceramic heater of the present invention having a long operating life by which an object to be heated being put directly thereon can be heated uniformly and of which heating efficiency is high and in which the heater main body is not large in size and is compact and scattering of impurities or particles is small can be easily produced inexpensively.

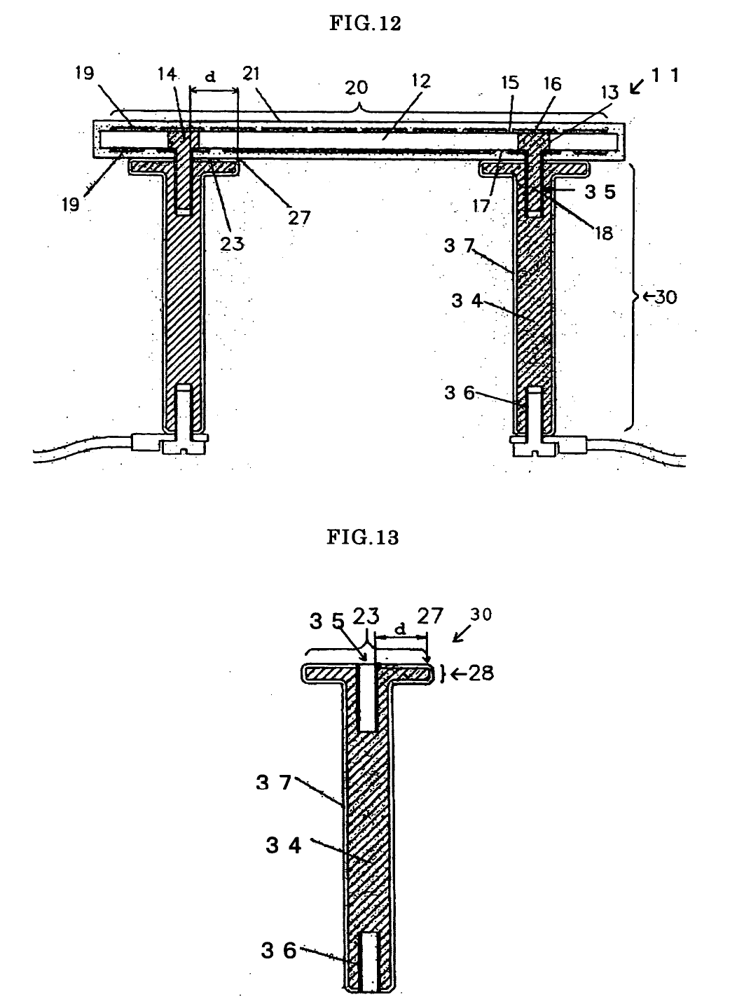

FIG. 12 is a cross-section view showing an example of another shape of the ceramic heater of the present invention. FIG. 13 is a cross-section view showing an example of the heater power-supply component of the present invention.

It is possible that the ceramic heater 11 includes a heater power-supply component 30 that is connected to the projecting portion of the joint member 14 and that is a separate member from the joint member 14;

the heater power-supply component 30 includes, a conductive member 34 with a rod shape made of conductive ceramics having a concave portion 35 in one end thereof that the projecting portion 18 of the joint member is inserted into and connected with and having a power terminal 36 in another end thereof to be connected to a power source, and a protection layer 37 made of insulating ceramics provided on an outer surface of the conductive member 34; and

a distance d from an outermost part 27 of an end face 23 in the one end that the joint member 14 is connected with to the concave portion 35 therein is 3 mm or more.

Moreover, when the joint member 14 projects from the plate member 12 and the projecting portion 18 constitutes a terminal on which the coating layer 21 is not formed and thereby the heater includes a heater power-supply component 30 that is connected to the projecting portion 18 of the joint member 14 and that is a separate member from the joint member 14, the heater becomes difficult to be damaged. For example, even when the heater power-supply component 30 or particularly a protection layer 37 provided therein is damaged, only the component can be exchanged. Therefore, the operating life of the heater can be long and the production cost can be reduced.

Furthermore, when the heater power-supply component 30 includes the conductive member 34 made of conductive ceramics having a concave portion 35 in one end thereof that the projecting portion 18 of the joint member is inserted into and connected with and having a power terminal 36 in another end thereof to be connected to a power source and the protection layer 37 made of insulating ceramics provided on an outer surface of the conductive member, the conductive member 34 made of conductive ceramics is protected from the process gas by the protection layer made of insulating ceramics.

And, when the conductive member 34 of the heater power-supply component 30 has a rod shape, there is a sufficient distance between the power terminal 36 that is the junction with a conductive wire or the like and the heater main body 11. Therefore, the temperature is low at the junction with a conductive wire or the like. Degradation of such a member as a crimping terminal or a bolt or a screw or a nut or the like which is used in the connection, and scattering of particles due thereto, can be suppressed.

Moreover, when the heater power-supply component 30 has a distance d from an outermost part 27 of an end face 23 in the one end that the joint member 14 is connected with to the concave portion 35 therein that is 3 mm or more, in the case of using a gas reacting with the conductive ceramics at a high temperature as a process gas, by performing the connection so that the protection layer 37 on the end face 23 in the one end of the heater power-supply component 30 connected with the joint member 14 and the coating layer 21 of the ceramic heater main body 11 are attached firmly, a gap between the protection layer 37 and the coating layer 21 is made to almost completely disappear and the process gas is insulated. Therefore, the conductive ceramics of the projecting portion 18 and the concave portion 35 can be prevented from being wasted by invasion of the process gas. Furthermore, thereby, abnormal generation of heat in the junction and further generation of electric discharge can be prevented and supply of current in the junction can be assured.

In particular, it is preferable that the distance d is 6 mm or more. And, 10 mm or more is more preferable because a gap that the process gas can invade can be made to completely disappear. Moreover, 20 mm or less is preferable because material of the member is not wasted and the cost is low.

It is preferable that the heater power-supply component 30 has a guard portion 28 in the one end that the joint member 14 is connected with. Thereby, the end face 23 of the one end that the joint member 14 is connected with can be easily broadened and a distance d from an outermost part 27 of an end face 23 to the concave portion 35 therein can be set to be 3 mm or more.

Moreover, when the portion having the power terminal 36 except the guard portion 28 has a thin rod shape, amount of heat to outflow to the outside through the heater power-supply component 30 from the heater can be small, and therefore, the heating uniformity of the heater can be improved. For example, the diameter of the guard portion 28 can be set to be 10 mm to 50 mm and the diameter of the rod portion except the guard portion 28 can be set to be 7 mm to 20 mm.

In the concave portion 35 of the heater power-supply component 30, an exposed portion on which the protection layer 37 is not formed for the electrical connection with the projecting portion 18 of the joint member. The size of the concave portion 35 is required to be a size being capable of inserting and connecting the projecting portion 18 of the joint member thereto. For example, the size of the concave portion 35 can be 2-5 mm.

The conductive member 34 of the heater power-supply component 30 is sufficient as long as made of conductive ceramics. However, it is preferable that the conductive member is made of any one of, graphite, sintered silicon carbide, and sintered boron carbide. Thereby, conductivity thereof is high and additionally the melting point is high, and therefore, heat resistance thereof becomes excellent, and additionally, scattering of impurities is small, and therefore the heater becomes stably applicable to heating process of 1000° C. or more in which high purity is required. In particular, graphite is more preferable because it is relatively inexpensive and easy to be processed.

Moreover, when the protection layer 37 of the heater power-supply component 30 is made of insulating ceramics, scattering of impurities or particles from the heater power-supply component 30 can be suppressed, and in the heater, the heater power-supply component 30 is insulated from a peripheral member thereof, and therefore, electric discharge between the heater power-supply component 30 and the peripheral member can be prevented.

And, when the protection layer 37 is entirely formed except the concave portion 35 and the power terminal 36 for being connected to a conductive wire or the like and when the concave portion 35 and the projecting portion 18 are connected so that the protection layer 37 is attached firmly to the coating layer 21 made of insulating ceramics of the heater main body, the heater becomes being capable of being used under the process gas being reactive with the joint member 14 or the conductive member 34 of the heater power-supply component 30. Electric discharge, heater damage, or scattering of impurities or particles which is caused by corrosion by the reactive atmosphere can be suppressed effectively.

It is preferable that a material of such a protection layer 37 is made of any one of, pyrolytic boron nitride, pyrolytic boron nitride containing carbon, pyrolytic boron nitride containing silicon, and pyrolytic boron nitride containing aluminum. Thereby, the conductive member 34 can be protected from corrosion due to the process gas, and also, it is easily produced by chemical vapor deposition method. And, even when used at a high-temperature process in the vicinity of 1500° C. and furthermore at a rapidly rising or falling temperature of 100° C./min or more, the heater can be stably used and causes no scattering of impurities, and therefore, the heater also becomes applicable to heating process in which high purity is required.

The thickness of the protection layer 37 is not particularly limited. However, it is desirable that the thickness is 20-300 μm and particularly 50-200 μm. If thicker than 20 μm, there is not a risk of dielectric breakdown, and if thinner than 300 μm, delamination or the like is not caused.

Here, in the case that the protection layer 37 is made of pyrolytic boron nitride containing carbon or pyrolytic boron nitride containing silicon or pyrolytic boron nitride containing aluminum, the resistivity becomes smaller as the carbon content or the silicon content or the aluminum content becomes larger. Therefore, the carbon content or the silicon content or the aluminum content is required to be suppressed to amount by which insulation can be held between the power-supply component and a peripheral member thereof.

It is preferable that a female screw is formed on the concave portion and a male screw is formed on the projecting portion 18 of the joint member 14 and the male screw is screwed together to the female screw and thereby the concave portion 35 of the heater power-supply component 30 is connected to the joint member. Thereby, the portions of the female screw and the male screw are not degraded with being exposed directly to a reactive atmosphere, and the electric contact can be assured. Also, even when the heater power-supply component 30 or particularly a protection layer 37 provided therein is damaged, only the component can be exchanged. Therefore, the operating life of the heater can be long and the production cost can be reduced.

Furthermore, assembly thereof is easy and space is not wasted in storage or transportation, and therefore the heater can be high in convenience. In addition, the protection layer 37 and the coating layer 21 can be firmly attached solidly, and insulating effect of the process gas is high.

In particular, because the heater power-supply component 30 of the present invention has a distance from an outermost part 27 of an end face 23 in the one end that the projecting portion 18 of the joint member 14 is connected with to the concave portion 35 therein that is 3 mm or more, by performing the connection so that the protection layer 37 on the end face 23 in the one end of the heater power-supply component 30 and the coating layer 21 of the ceramic heater main body 11 are attached firmly, the process gas is difficult to reach the conductive ceramics of the projecting portion 18 and the concave portion 35. Therefore, the conductive ceramics of the projecting portion 18 and the concave portion 35 is not wasted, and the operating life of the heater is very long.

As described above, the case that the heater power-supply component 30 of the present invention is connected to the main body of the ceramic heater 11 of the present invention has been explained. The present invention is not necessarily limited to the component connected to the projecting portion 18 of the joint member 14 of the main body of the ceramic heater 11. The power-supply component to be connected to a joint terminal of a main body of a general ceramic heater is possible, and thereby, the junction can be difficult to be invaded.

### EXAMPLE

Hereinafter, the present invention will be explained more specifically with reference to Example and Comparative example. However, the present invention is not limited thereto.

### Example 1

First, the plate member made of pyrolytic boron nitride having a diameter of 310 mm and a thickness of 2.5 mm was produced by reacting 4 SLM of ammonium and 2 SLM of boron trichloride under a pressure of 10 Torr at a temperature of 1850° C. The through-holes having a diameter of 12 mm were provided in two places on a 102 mm radius from the center of this plate member and in two places on a 111 mm radius therefrom.

Next, after cylindrical joint members (diameter: 12 (mm)+0.1-0.2 (mm)) made of graphite (manufactured by Toyo Tanso Co., Ltd., IG-110) were pressed-fit into the through-holes, flat-surface processing was performed so that an end face of each of the joint members had the same plane with the plate member. Moreover, the other end of each of the cylinders was cut at the part of 20 mm from the plate member, and processed to a screw of M6 and thereby the male screw was formed.

Next, on the plate member and the joint members formed as described above as shown in FIGS. 2 and 3, the conductive layer made of a pyrolytic graphite containing boron carbide having a thickness of 50 μm was provided by pyrolyzing 3 SLM of methane and 0.1 SLM of boron trichloride under a pressure of 5 Torr at a temperature of 1750° C., the heater pattern as FIG. 4 was formed by machining therein, and thereby, this was made to be a ceramic heater having two-zone system.

The first heating region in the central part of the heater and the second heating region located in the outside thereof were divided at the part of a 108.8 mm radius as shown as “A” in FIG. 4. The first heating region had an almost concentric-circle shape and the second heating region had a ring shape.

The conductive layer formed on the back surface was partially removed by subjecting the surrounds of the joint members to machining as shown in FIG. 5. Furthermore, on the ceramic heater, the plate member and the joint members and the conductive layer except the projecting portion 18 of the joint member 14 were integrally coated with an insulator film made of pyrolytic boron nitride by reacting 5 SLM of ammonium and 2 SLM of boron trichloride under the condition of a pressure of 10 Torr and a temperature of 1890° C., and thereby, a ceramic heater for heating a semiconductor wafer having a large diameter of 300 mm (12 inches) as shown in FIG. 1 was completed.

This heater was set to a vacuum chamber and a thermocouple for measuring temperature was attached to the heater and then pressure inside the chamber was depressurized to 5 Pa with a vacuum pump. Then, current was supplied in this heater and a heat cycle examination was performed. With setting the temperature rising rate to 150° C./min and the temperature falling rate to 100° C./min, rising and falling of the temperature could be repeated between 300-1100° C. by 500 times with no problem. After the heat cycle examination, the ceramic heater was gotten out of the vacuum chamber and the appearance thereof was confirmed. Therefore, abnormality such as crack or delamination was not observed on the insulator film.

Furthermore, on the conductive member with a cylindrical rod shape made of graphite (manufactured by Toyo Tanso Co., Ltd., IG-110) having a diameter of 12 mm and a length of 100 mm, the coating layer made of a pyrolytic boron nitride with a thickness of 200 μm by reacting 5 SLM of ammonium and 2 SLM of boron trichloride under the condition of a pressure of 10 Torr and a temperature of 1890° C. Then, the female screw of M6 was formed on one end of the conductive member, and on the other end thereof, a female screw of M6 was formed in the same manner for being connected to a conductive wire from a power source.

As shown in FIG. 8, the conductive member was connected to the above-described main body of the ceramic heater 11 of the present invention, and thereby, the heater as shown in FIG. 9 was completed. This was set in a chamber, and a thermocouple for measuring temperature was attached to the heater, and a silicon wafer with a diameter of 300 mm was put on the heater. Then, 6 Vol % H₂/Ar was supplied at a flow amount of 200 ml/min.

After the atmosphere in the chamber was replaced, current was supplied in this heater and heating was performed at 1100° C. for 10 hr and thereby it was possible that the entire plane of the wafer was heated uniformly. Moreover, under the same condition, a continuous heating examination of the heater was performed at 1100° C. for 500 hr. Electric discharge or breaking was not generated on the way. It was possible that the continuous heating examination was performed for 500 hr with no problem.

As described above, with respect to the ceramic heater according to the present invention, even if it is a heater for heating a semiconductor wafer having a large diameter of 300 mm (12 inches), it is not necessary that the positions in which the joint members are provided are made to be outside the region on the plate member on which a semiconductor wafer is put, and therefore, it has become possible that by the heater having the heater main body does not become large in size and has a compact structure whose diameter is only approximately 310 mm, an object to be heated is heated uniformly with high heating efficiency and scattering of impurities is not caused in the heating, and therefore the heater also becomes applicable to heating process in which high purity is required.

Furthermore, there was a trouble that the conductive member was damaged in the operation. However, it was easily exchanged to a spare conductive member. And, the heat treatment was smoothly started again. It was confirmed that the operating life of the heater was long.

### Example 2

First, the plate member made of pyrolytic boron nitride having a diameter of 310 mm and a thickness of 2.5 mm was produced by reacting 4 SLM of ammonium and 2 SLM of boron trichloride under a pressure of 6 Torr (800 Pa) at a temperature of 1850° C. The through-holes having a diameter of 12 mm were provided in two places on a 130 mm radius from the center of this plate member.

Next, after cylindrical joint members (diameter: 12 (mm)+0.005-0.015 (mm)) made of graphite (manufactured by Toyo Tanso Co., Ltd., IG-110) were pressed-fit into the through-holes, flat-surface processing was performed so that an end face of each of the joint members had the same plane with the plate member. Moreover, the other end of each of the cylinders was cut at the part of 20 mm from the plate member, and processed to a screw of M5 and thereby the male screw was formed.

Next, on the plate member and the joint members formed as described above, a conductive layer made of pyrolytic graphite containing boron carbide having a thickness of 50 μm was provided by pyrolyzing 3 SLM of methane and 0.1 SLM of boron trichloride under a pressure of 5 Torr (667 Pa) at a temperature of 1750° C., and by machining therein, a ceramic heater having one-zone system was produced. The conductive layer formed on the back surface was partially removed by subjecting only vicinities of the joint members to machining so that the joint members are electrically insulated not to be short-circuited to each other.

Furthermore, on the ceramic heater, the plate member and the joint members and the conductive layer except the projecting portion 18 of the joint member 14 were integrally coated with an insulator film made of pyrolytic boron nitride by reacting 5 SLM of ammonium and 2 SLM of boron trichloride under the condition of a pressure of 10 Torr (1333 Pa) and a temperature of 1890° C., and thereby, the ceramic heater main body as shown in FIG. 1 was completed.

Furthermore, as FIG. 13, on the conductive member with a rod shape made of graphite (manufactured by Toyo Tanso Co., Ltd., IG-110) with a diameter of 10 mm and a length of 100 mm having a guard portion with a diameter of 30 mm in the range of 3 mm from the end face of only one end thereof, the protection layer made of pyrolytic boron nitride with a thickness of 200 μm by reacting 5 SLM of ammonium and 2 SLM of boron trichloride under the condition of a pressure of 5 Torr (667 Pa) and a temperature of 1890° C. Then, the female screw of M5 was formed on one end of the conductive member, and on the other end thereof, a female screw of M5 was formed in the same manner for being connected to a conductive wire from a power source, and thereby, the heater power-supply component was completed. The distance d from an outermost part of the end face having a diameter of 30 mm to the concave portion on which the female screw was formed was approximately 12.5 mm.

The heater power-supply component was connected to the main body of the ceramic heater of the present invention of FIG. 1, and thereby, the heater as shown in FIG. 12 was completed. This was set in a chamber, and a thermocouple for measuring temperature was attached to the heater, and a silicon wafer with a diameter of 300 mm was put on the heater. Then, 6 Vol % H₂/Ar was supplied at a flow amount of 200 ml/min.

After the atmosphere in the chamber was replaced, current was supplied in this heater and heating was performed at 1100° C., and thereby it was possible that the entire plane of the wafer was heated uniformly. Moreover, under the same condition, a continuous heating examination of the heater was performed at 1100° C. for 500 hr. Electric discharge or breaking was not generated on the way. It was possible that the continuous heating examination was performed for 500 hr with no problem.

Furthermore, after the continuous heating examination, the heater power-supply component was detached. And, the concave portion of the heater power-supply component and the joint terminal portion of the projecting portion were confirmed. However, abnormality in appearance was not observed in the screw.

As described above, with respect to the ceramic heater according to the present invention, it is not necessary that the positions in which the joint members are provided are made to be outside the region on the plate member on which a semiconductor wafer is put, and therefore, it has become possible that by the heater having the heater main body does not become large in size and has a compact structure, an object to be heated is heated uniformly with high heating efficiency and scattering of impurities is not caused in the heating, and therefore the heater also becomes applicable to heating process in which high purity is required.

Furthermore, there was a trouble that the heater power-supply component was damaged in the operation. However, it was easily exchanged to a spare heater power-supply component. And, the heat treatment was smoothly started again. It was confirmed that the operating life of the heater was long.

### Examples 3-5

The conductive members with a rod shape made of graphite (manufactured by Toyo Tanso Co., Ltd., IG-110) having a guard portion with a diameter of 11 mm (Example 3) and 15 mm (Example 4) and 25 mm (Example 5) were used, the heater power-supply components so as to respectively have the distances d of approximately 3 mm, approximately 5 mm, and approximately 10 mm, were produced. Then, they were connected to the main bodies of the ceramic heaters of the present invention of FIG. 1 in the same manner with Example 2, and thereby the ceramic heaters as shown in FIG. 12 were completed. The continuous heating examinations of the heaters were performed at 1100° C. for 500 hr. Electric discharge or breaking was not generated on the way. It was possible that the continuous heating examinations were performed for 500 hr with no problem.

Furthermore, after the heating examinations, the heater power-supply components were detached. And, the concave portion of each of the heater power-supply components and the joint terminal portion of each of the projecting portions were confirmed. However, abnormality in appearance was not observed in the screws, similarly to Example 2.

### Comparative Example 1

First, the plate member made of pyrolytic boron nitride having a diameter of 350 mm that is larger than that of Example and having a thickness of 2.5 mm was produced by reacting 4 SLM of ammonium and 2 SLM of boron trichloride under a pressure of 10 Torr at a temperature of 1850° C. Then, on the plate member, the conductive layer made of pyrolytic graphite containing boron carbide having a thickness of 50 μm was provided by pyrolyzing 3 SLM of methane and 0.1 SLM of boron trichloride under a pressure of 5 Torr at a temperature of 1750° C., the heater pattern having a conductive pathways 6 with two-zone system as FIG. 10 was formed by machining therein.

And, two pairs of through-holes with a diameter of 5 mm were provided in the peripheral part of the plate member as FIG. 10. By graphite (manufactured by Toyo Tanso Co., Ltd., IG-110) screws of M5, graphite rod members with a cylindrical shape having a diameter of 10 mm and a length of 6 mm were fixed to the through-holes. In this case, graphite washers were pinched between the graphite screw and the heater main body and between the heater main body and the graphite cylinder.

Furthermore, on the ceramic heater, the plate member and the graphite rod members and the graphite screws were integrally coated with an insulator film made of pyrolytic boron nitride by reacting 5 SLM of ammonium and 2 SLM of boron trichloride under the condition of a pressure of 10 Torr and a temperature of 1890° C., and thereby, the ceramic heater was completed.

However, this heater was difficult to be handled, and the graphite rod member was occasionally damaged by mistake before the heater was set to a chamber. In this case, although the heater main body in itself was not damaged, the damaged graphite cylinder could not be exchanged because the graphite rod member and the heater main body were integrally coated with the insulating film. Therefore, the heater could not be attached to the chamber and therefore the heating examination could not be performed.

Moreover, in the case that the graphite rod member was connected by the graphite screws as described above, the surface was not flat due to the screws, and therefore, for heating the wafer with a diameter of 300 mm, the heater had to have a large size with a diameter of approximately 350 mm, and the power terminal had to be formed in the peripheral part thereof, and this caused cost rise. Furthermore, the conductive pathways 6 were required and also temperature distribution in the wafer plane was bad.

### Comparative Example 2

First, the plate member made of pyrolytic boron nitride having a diameter of 350 mm that is larger than that of Example and having a thickness of 2.5 mm was produced by reacting 4 SLM of ammonium and 2 SLM of boron trichloride under a pressure of 6 Torr (800 Pa) at a temperature of 1850° C. Then, on the plate member, the conductive layer made of pyrolytic graphite containing boron carbide having a thickness of 50 μm was provided by pyrolyzing 3 SLM of methane and 0.1 SLM of boron trichloride under a pressure of 5 Torr (667 Pa) at a temperature of 1750° C., and the heater pattern was formed by machining therein.

And, two pairs of through-holes with a diameter of 10 mm were provided in the peripheral part of the plate member as FIG. 11. By graphite (manufactured by Toyo Tanso Co., Ltd., IG-110) screws of M5, graphite rod members with a cylindrical shape having a diameter of 10 mm and a length of 60 mm were fixed to the through-holes. In this case, graphite washers were pinched between the graphite screw and the heater main body and between the heater main body and the graphite cylinder.

Furthermore, on the ceramic heater, the plate member and the graphite rod members and the graphite screws were integrally coated with an insulator film made of pyrolytic boron nitride by reacting 5 SLM of ammonium and 2 SLM of boron trichloride under the condition of a pressure of 5 Torr (667 Pa) and a temperature of 1890° C., and thereby, the ceramic heater was completed.

However, this heater was difficult to be handled, and the graphite rod member was occasionally damaged by mistake before the heater was set to a chamber. In this case, although the heater main body in itself was not damaged, the damaged graphite cylinder could not be exchanged because the graphite rod member and the heater main body were integrally coated with the insulating film. Therefore, the heater could not be attached to the chamber and therefore the heating examination could not be performed.

Moreover, in the case that the graphite rod member was connected by the graphite screws as described above, the surface was not flat due to the screws, and therefore, the junction had to be formed in the peripheral part thereof, and this caused cost rise.

The present invention is not limited to the above-described embodiments. The above-described embodiments are mere examples and those having the substantially same constitution as that described in the appended claims and providing the similar functions and advantages are included in the scope of the present invention.

What is claimed is:

1. A ceramic heater comprising: at least
a plate member made of insulating ceramics in which one or more pair(s) of through-holes are formed;
a conductive layer made of conductive ceramics formed on the plate member; and
a coating layer made of insulating ceramics formed on the conductive layer;
wherein a joint member made of conductive ceramics is inserted into the through-hole of the plate member;
an end face of the joint member inserted into the through-hole has a same plane with a main surface of the plate member on which the conductive layer is formed;
the joint member is coated with the conductive layer and thereby fixed to the plate member and also connected with the conductive layer having a heater pattern formed on a main surface of the plate member; and
a side of the joint member opposite to a side thereof inserted into the through-hole of the plate member projects from the plate member and the projecting portion constitutes a terminal on which the coating layer is not formed.

2. The ceramic heater according to claim 1, wherein the joint member is pressed-fit into the through-hole of the plate member.

3. The ceramic heater according to claim 1, wherein the heater pattern is formed on the main surface of the plate member having the same plane with the end face in the side of the joint member inserted into the through-hole of the plate member and/or on a main surface opposite to the main surface, and in the main surface on which the heater pattern is not formed, the joint members are electrically insulated not to be short-circuited to each other.

4. The ceramic heater according to claim 2, wherein the heater pattern is formed on the main surface of the plate member having the same plane with the end face in the side of the joint member inserted into the through-hole of the plate member and/or on a main surface opposite to the main surface, and in the main surface on which the heater pattern is not formed, the joint members are electrically insulated not to be short-circuited to each other.

5. The ceramic heater according to claim 1, wherein the plate member is made of any one of, pyrolytic boron nitride, pyrolytic boron nitride containing carbon, pyrolytic boron nitride containing silicon, and pyrolytic boron nitride containing aluminum.

6. The ceramic heater according to claim 1, wherein the joint member is made of any one of, graphite, sintered silicon carbide, and sintered boron carbide.

7. The ceramic heater according to claim 1, wherein the conductive layer is made of any one of pyrolytic graphite and pyrolytic graphite containing boron and/or boron carbide.

8. The ceramic heater according to claim 1, wherein the projecting portion of the joint member is inserted into a concave portion provided on one end of a conductive member with a rod shape that is a separate member from the joint member and that is made of conductive ceramics or metal, and thereby connected with the conductive member.

9. The ceramic heater according to claim 4, wherein the projecting portion of the joint member is inserted into a concave portion provided on one end of a conductive member with a rod shape that is a separate member from the joint member and that is made of conductive ceramics or metal, and thereby connected with the conductive member.

10. The ceramic heater according to claim 1:
wherein the ceramic heater includes a heater power-supply component that is connected to the projecting portion of the joint member and that is a separate member from the joint member;
the heater power-supply component includes, a conductive member with a rod shape made of conductive ceramics having a concave portion in one end thereof that the projecting portion of the joint member is inserted into and connected with and having a power terminal in another end thereof to be connected to a power source, and a protection layer made of insulating ceramics provided on an outer surface of the conductive member; and
a distance from an outermost part of an end face in the one end that the joint member is connected with to the concave portion therein is 3 mm or more.

11. The ceramic heater according to claim 4:
wherein the ceramic heater includes a heater power-supply component that is connected to the projecting portion of the joint member and that is a separate member from the joint member;
the heater power-supply component includes, a conductive member with a rod shape made of conductive ceramics having a concave portion in one end thereof that the projecting portion of the joint member is inserted into and connected with and having a power terminal in another end thereof to be connected to a power source, and a protection layer made of insulating ceramics provided on an outer surface of the conductive member; and
a distance from an outermost part of an end face in the one end that the joint member is connected with to the concave portion therein is 3 mm or more.

12. The ceramic heater according to claim 10, wherein the heater power-supply component has a guard portion in the one end that the joint member is connected with.

13. The ceramic heater according to claim 11, wherein the heater power-supply component has a guard portion in the one end that the joint member is connected with.

14. The ceramic heater according to claim 8, wherein a male screw is formed on the projecting portion, a female screw is formed on the concave portion of the conductive member, the male screw is screwed together to the female screw, and thereby the projecting portion of the joint member is connected to the conductive member.

15. The ceramic heater according to claim 13, wherein a male screw is formed on the projecting portion, a female screw is formed on the concave portion of the conductive member, the male screw is screwed together to the female screw, and thereby the projecting portion of the joint member is connected to the conductive member.

16. The ceramic heater according to claim 8, wherein the conductive member is made of any one of, graphite, graphite coated with pyrolytic graphite containing boron and/or boron carbide on an outer surface thereof, sintered silicon carbide, sintered boron carbide, tantalum, tungsten, molybdenum, inconel, nickel, and stainless.

17. The ceramic heater according to claim 10, wherein the conductive member is made of any one of, graphite, graphite coated with pyrolytic graphite containing boron and/or boron carbide on an outer surface thereof, sintered silicon carbide, sintered boron carbide, tantalum, tungsten, molybdenum, inconel, nickel, and stainless.

18. The ceramic heater according to claim 9, wherein the conductive member is surrounded by a tubular member made of insulating ceramics.

19. The ceramic heater according to claim 15, wherein the conductive member is surrounded by a tubular member made of insulating ceramics.

20. The ceramic heater according to claim 18, wherein the tubular member has a bottom in one end thereof and is provided with a through-hole in a central part of the bottom, a bottom face of the bottom is in contact with a heater main body, the projecting portion of the joint member is inserted into the through-hole thereof, further the conductive member is inserted into the tubular member, and thereby the tubular member surrounds the conductive member.

21. The ceramic heater according to claim 19, wherein the tubular member has a bottom in one end thereof and is provided with a through-hole in a central part of the bottom, a bottom face of the bottom is in contact with a heater main body, the projecting portion of the joint member is inserted into the through-hole thereof, further the conductive member is inserted into the tubular member, and thereby the tubular member surrounds the conductive member.

22. The ceramic heater according to claim 9, wherein a protection layer made of insulating ceramics is formed on the conductive member.

23. The ceramic heater according to claim 15, wherein a protection layer made of insulating ceramics is formed on the conductive member.

24. The ceramic heater according to claim 1, wherein the coating layer, the tubular member, or the protection layer on the conductive member, is made of any one of, pyrolytic boron nitride, pyrolytic boron nitride containing carbon, pyrolytic boron nitride containing silicon, and pyrolytic boron nitride containing aluminum.

25. The ceramic heater according to claim 18, wherein the coating layer, the tubular member, or the protection layer on the conductive member, is made of any one of, pyrolytic boron nitride, pyrolytic boron nitride containing carbon, pyrolytic boron nitride containing silicon, and pyrolytic boron nitride containing aluminum.

26. The ceramic heater according to claim 22, wherein the coating layer, the tubular member, or the protection layer on the conductive member, is made of any one of, pyrolytic boron nitride, pyrolytic boron nitride containing carbon, pyrolytic boron nitride containing silicon, and pyrolytic boron nitride containing aluminum.

27. The ceramic heater according to claim 23, wherein the coating layer, the tubular member, or the protection layer on the conductive member, is made of any one of, pyrolytic boron nitride, pyrolytic boron nitride containing carbon, pyrolytic boron nitride containing silicon, and pyrolytic boron nitride containing aluminum.

28. A method for producing a ceramic heater, comprising at least steps of:
forming one or more pair(s) of through-holes in a plate member made of insulating ceramics;
forming a conductive layer made of conductive ceramics on the plate member; and then
forming a coating layer made of insulating ceramics on the conductive layer;
wherein a joint member made of conductive ceramics is inserted into the through-hole of the plate member so that an end face of the joint member inserted into the through-hole has a same plane with a main surface of the plate member and so that a side of the joint member opposite to a side thereof inserted into the through-hole projects from the plate member; then
the conductive layer is formed so that the joint member and the plate member are integrally coated therewith and thereby the joint member and the plate member are firmly fixed;
a heater pattern is formed by processing the conductive layer on a main surface of the plate member; and then
the coating layer is formed so that the plate member and the joint member and the conductive layer are integrally coated therewith except the projecting portion of the joint member.

29. The method for producing a ceramic heater according to claim 28, wherein the joint member is inserted into the through-hole of the plate member by press-fit.

30. The method for producing a ceramic heater according to claim 28, wherein the heater pattern is formed on the main surface of the plate member having the same plane with the end face in the side of the joint member inserted into the through-hole of the plate member and/or on a main surface opposite to the main surface, and the conductive layer in the main surface on which the heater pattern is not formed is partially or entirely removed so that the joint members electrically insulated not to be short-circuited to each other.

31. The method for producing a ceramic heater according to claim 29, wherein the heater pattern is formed on the main surface of the plate member having the same plane with the end face in the side of the joint member inserted into the through-hole of the plate member and/or on a main surface opposite to the main surface, and the conductive layer in the main surface on which the heater pattern is not formed is partially or entirely removed so that the joint members electrically insulated not to be short-circuited to each other.

32. The method for producing a ceramic heater according to claim 28, wherein as the plate member, any one of, pyrolytic boron nitride, pyrolytic boron nitride containing carbon, pyrolytic boron nitride containing silicon, and pyrolytic boron nitride containing aluminum, is used.

33. The method for producing a ceramic heater according to claim 28, wherein as the joint member, any one of, graphite, sintered silicon carbide, and sintered boron carbide, is used.

34. The method for producing a ceramic heater according to claim 28, wherein the conductive layer is formed by chemically vapor-depositing any one of pyrolytic graphite and pyrolytic graphite containing boron and/or boron carbide.

35. The method for producing a ceramic heater according to claim 28, wherein the projecting portion of the joint member is inserted into a concave portion formed on one end of a conductive member with a rod shape that is a separate member from the joint member and that is made of conductive ceramics or metal, and thereby connected with the conductive member.

36. The method for producing a ceramic heater according to claim 31, wherein the projecting portion of the joint member is inserted into a concave portion formed on one end of a conductive member with a rod shape that is a separate member from the joint member and that is made of conductive ceramics or metal, and thereby connected with the conductive member.

37. The method for producing a ceramic heater according to claim 35, wherein the connection of the projecting portion of the joint member with the conductive member is performed by, forming a male screw on the projecting portion of the joint member, forming a female screw on the concave portion of the conductive member, and screwing together the male screw to the female screw.

38. The method for producing a ceramic heater according to claim 36, wherein the connection of the projecting portion of the joint member with the conductive member is performed by, forming a male screw on the projecting portion of the joint member, forming a female screw on the concave portion of the conductive member, and screwing together the male screw to the female screw.

39. The method for producing a ceramic heater according to claim 35, wherein as the conductive member, any one of, graphite, graphite coated with pyrolytic graphite containing boron and/or boron carbide on an outer surface thereof, sintered silicon carbide, sintered boron carbide, tantalum, tungsten, molybdenum, inconel, nickel, and stainless, is used.

40. The method for producing a ceramic heater according to claim 35, wherein the conductive member is surrounded by a tubular member made of insulating ceramics.

41. The method for producing a ceramic heater according to claim 38, wherein the conductive member is surrounded by a tubular member made of insulating ceramics.

42. The method for producing a ceramic heater according to claim 40, wherein the surrounding by the tubular member is performed by, forming a bottom in one end of the tubular member made of insulating ceramics, providing a through-hole in a central part of the bottom, inserting the projecting portion of the joint member into the through-hole thereof, contacting a bottom face of the bottom with a heater main body, and further inserting and fixing the projecting portion into the conductive member.

43. The method for producing a ceramic heater according to claim 41, wherein the surrounding by the tubular member is performed by, forming a bottom in one end of the tubular member made of insulating ceramics, providing a through-hole in a central part of the bottom, inserting the projecting portion of the joint member into the through-hole thereof, contacting a bottom face of the bottom with a heater main body, and further inserting and fixing the projecting portion into the conductive member.

44. The method for producing a ceramic heater according to claim 35, wherein the conductive member that a protection layer made of insulating ceramics is formed on a surface thereof is used.

45. The method for producing a ceramic heater according to claim 38, wherein the conductive member that a protection layer made of insulating ceramics is formed on a surface thereof is used.

46. The method for producing a ceramic heater according to claim 28, wherein as the coating layer or the tubular member or the protection layer on the conductive member, any one of, pyrolytic boron nitride, pyrolytic boron nitride containing carbon, pyrolytic boron nitride containing silicon, and pyrolytic boron nitride containing aluminum, is used.

47. The method for producing a ceramic heater according to claim 40, wherein as the coating layer or the tubular member or the protection layer on the conductive member, any one of, pyrolytic boron nitride, pyrolytic boron nitride containing carbon, pyrolytic boron nitride containing silicon, and pyrolytic boron nitride containing aluminum, is used.

48. The method for producing a ceramic heater according to claim 44, wherein as the coating layer or the tubular member or the protection layer on the conductive member, any one of, pyrolytic boron nitride, pyrolytic boron nitride containing carbon, pyrolytic boron nitride containing silicon, and pyrolytic boron nitride containing aluminum, is used.

49. A heater power-supply component comprising: at least
a conductive member with a rod shape made of conductive ceramics having a concave portion in one end thereof that a joint terminal of a ceramic heater main body can be inserted into and connected with and having a power terminal in another end thereof to be connected to a power source; and
a protection layer made of insulating ceramics provided on an outer surface of the conductive member; and
wherein a distance from an outermost part of an end face in the one end that the joint terminal is connected with to the concave portion therein is 3 mm or more.

50. The heater power-supply component according to claim 49, wherein the heater power-supply component has a guard portion in the one end that the joint terminal can be connected with.

51. The heater power-supply component according to claim 49, wherein the conductive member is made of any one of, graphite, sintered silicon carbide, and sintered boron carbide.

52. The heater power-supply component according to claim 49, wherein the protection layer is made of any one of, pyrolytic boron nitride, pyrolytic boron nitride containing carbon, pyrolytic boron nitride containing silicon, and pyrolytic boron nitride containing aluminum.

53. The heater power-supply component according to claim 49, wherein on the concave portion, a female screw is formed.

54. The heater power-supply component according to claim 50, wherein on the concave portion, a female screw is formed.
